(19) United States
(12) Patent Application Publication
(10) Pub. No.: US 2025/0141956 A1
(43) Pub. Date: May 1, 2025

(54) ENABLEMENT OF COMMON APPLICATION PROGRAMMING INTERFACE FRAMEWORK INVOCATION BY USER EQUIPMENT APPLICATIONS

(71) Applicant: CONVIDA WIRELESS, LLC, Wilmington, DE (US)

(72) Inventors: Catalina MLADIN, Hatboro, PA (US); Dale SEED, Allentown, PA (US); Quang LY, North Wales, PA (US); Lu LIU, Conshohocken, PA (US)

(21) Appl. No.: 18/833,625

(22) PCT Filed: Feb. 7, 2023
(86) PCT No.: PCT/US2023/062106

§ 371 Date: Jul. 26, 2024

Related U.S. Application Data
(60) Provisional application No. 63/307,278, filed on Feb. 7, 2022.

(51) Int. Cl. H04L 67/1061; H04L 67/141

(52) U.S. Cl. CPC H04L 67/1061; H04L 67/141

(57) ABSTRACT

Methods, systems, and devices may support capabilities of user equipment which may be part of an application programming interface (API) exposure system or deployment, such as common API framework (CAPIF).

### CROSS-REFERENCE TO RELATED APPLICATIONS

This application claims the benefit of U.S. Provisional Patent Application No. 63/307,278, filed on Feb. 7, 2022, entitled “Enablement of CAPIF API Invocation by UE Applications,” the contents of which are hereby incorporated by reference herein.

### BACKGROUND

In 3GPP, there are multiple northbound application programming interface (API)-related specifications. To avoid duplication and inconsistency of approaches between different API specifications and to specify common services (e.g., authorization), 3GPP has developed a common API framework (CAPIF) that includes common aspects applicable to any set of northbound service APIs. CAPIF may be standardized by 3GPP SA6. FIG. 1 shows the CAPIF functional model and the associated reference points as specified in 3GPP TS 23.222. Below are descriptions of the CAPIF function model as shown in FIG. 1.

CAPIF-1 and CAPIF-1e reference points connect an API invoker inside the PLMN Trust Domain and an API invoker outside the PLMN Trust Domain respectively, with the CAPIF core function.

CAPIF-2 and CAPIF-2e reference points connect an API invoker inside the PLMN Trust Domain and an API invoker outside the PLMN Trust Domain respectively, with the API exposing function.

CAPIF-3 reference point connects an API exposing function inside the PLMN Trust Domain with the CAPIF core function.

CAPIF-4 reference point connects an API publishing function inside the PLMN Trust Domain with the CAPIF core function.

CAPIF-5 reference point connects an API management function inside the PLMN Trust Domain with the CAPIF core function.

The API exposing function, API publishing function, and API management function are part the API provider domain which can be implemented by the Service Capability Exposure Function (SCEF) or the Network Exposure Function (NEF).

The CAPIF core function in the PLMN trust domain supports service APIs from both the PLMN trust domain and 3rd party trust domains having a business relationship with the PLMN Trust Domain. The API invokers may exist within the PLMN trust domain, or within the 3rd party trust domain or outside of both the PLMN trust domain and the 3rd party trust domain.

CAPIF-3e reference point connects an API exposing function outside PLMN Trust Domain with the CAPIF core function.

CAPIF-4e reference point connects an API publishing function outside PLMN Trust Domain with the CAPIF core function.

CAPIF-5e reference point connects an API management function outside PLMN Trust Domain with the CAPIF core function.

CAPIF-7 and CAPIF-7e reference points connect API exposing functions within PLMN Trust Domain and outside PLMN Trust Domains respectively. 3GPP TS 23.222 specifies functional model for interactions between API exposing functions.

The following CAPIF functional entities are represented in FIG. 1.

The API invoker is typically provided by a 3^{rd} party application provider who has a service agreement with the PLMN operator. The API invoker may reside within the same trust domain as the PLMN operator network.

The API invoker supports multiple capabilities, such as: supporting authenticating and obtaining authorization to access service APIs and discovering Service APIs using CAPIF-1/CAPIF-1e reference point; or supporting invoking the service APIs using CAPIF-2/CAPIF-2e reference point using, e.g., the T8 interface or the network exposure function (NEF) Northbound interface.

The CAPIF core function (CCF) supports the following capabilities over CAPIF-1/CAPIF-1e reference point: authenticating the API invoker; providing the authorization information; and service API discovery.

The CAPIF core function supports the following capabilities over CAPIF-3 and CAPIF-3e reference points: providing the service API access policy; providing the authentication and authorization information of API invoker for validation; providing API routing information; providing API topology hiding information; logging of service API invocations; and charging of service API invocations.

The CAPIF core function supports the following capabilities over CAPIF-4 and CAPIF-4e reference points: publishing and storing service API information.

The CAPIF core function supports the following capabilities over CAPIF-5 and CAPIF-5e reference points: providing service API invocation logs for auditing; providing monitoring information for the status of service APIs and storing configurations of the API provider policies; registering of API provider domain functions; and update registration information of API provider domain functions.

The CAPIF core function supports the following capabilities over CAPIF-6 and CAPIF-6e reference point: publishing of service API information with another CAPIF core function; and discovery of service API information with another CAPIF core function.

The API exposing function (AEF) is the provider of the service APIs and is also the service communication entry point of the service API to the API invokers using CAPIF-2/CAPIF-2e reference point. The API exposing function consists of capabilities such as authenticating the API invoker, validating the authorization provided by the CAPIF core function and logging the service API invocations at the CAPIF core function using CAPIF-3 and CAPIF-3e reference points.

In distributed deployment scenarios it is possible that the CAPIF can be deployed by splitting the functionality of the API exposing function among multiple API exposing function entities, of which one acts as the entry point. The source API exposing function communicates with the destination API exposing function over CAPIF-7/7e reference points.

The API publishing function (APF) enables the API provider to publish service API information using CAPIF-4 and CAPIF-4e reference points in order to enable the discovery of service APIs by the API invoker.

The API management function (AMF) enables the API provider to perform administration of the service APIs. The API management function supports several capabilities such as querying the service API invocation log for auditing, monitoring the events, configuring the API provider policies and monitoring the status of the service APIs, register and maintain registration information of the API provider domain functions on the CAPIF core function, using CAPIF-5 and CAPIF-5e reference points.

SNA in context of CAPIF: The Subscriber-aware Northbound API access (SNA) work item in 3GPP resulted in requirements for SNA that have been specified in TS 22.261, Clause 6.10.2. These requirements are to ensure that API access can be checked with the granularity of the individual 5G system subscriber invoking the API, particularly in the case that the API invocation impacts or is related to an individual 5G system subscriber's service experience. The possible use cases of SNA are: the application on the UE triggers the AF, and the AF invokes the northbound APIs (indirect API invocation); and the application on the UE directly invokes the northbound APIs (direct API invocation). It has been clarified that the UE triggering the API invocation may be different from the UE whose service experience gets affected by the API invocation (also referred to as the resource owner).

The control of northbound API access according to the SNA requirements can be realized by enhancing CAPIF, which defines the framework of capabilities for all the northbound APIs. Currently, CAPIF supports procedures for the northbound API access, for example, publishing and discovery of the northbound APIs, the authentication between the API invoker and the CAPIF core function, the authentication between the API invoker and the AEF, and the authorization of the API invoker to access service API.

3GPP concluded that the overall northbound APIs architecture needs to be enhanced to fulfil the SNA requirements, to explicitly consider the resource owner and the triggering UE, potentially enhancing publishing and discovery of APIs, or providing enhancements in the enabler layers (SEAL, EDGEAPP, etc.) to support SNA.

SNA intends to open up APIs to individual 5G system subscribers and to provide UE applications with the ability to be able to access SNA 5G system features independent of the UE OS. Potential solutions are expected to pay attention to this aspect as well.

FIG. 1 shows business relationships studied in TR 23.700-95 for the purpose of introducing this functionality in CAPIF. This business relationship can be applied to both AF- and UE-originated API invocation scenario, as the API invoker can be an application on the UE or the AF.

The API invoker has a service agreement with a CAPIF provider, and the API provider provides APIs associated with the resource owner. The CAPIF provider and the API provider can be part of the same organization (e.g., PLMN operator). When the CAPIF provider is a PLMN operator, the resource owner may be a subscriber of the PLMN.

This background information is provided to reveal information believed to be of possible relevance. No admission is necessarily intended, nor should be construed, that any of the preceding information constitutes prior art.

### SUMMARY

Disclosed herein are methods, systems, and devices that may support capabilities of user equipment which may be part of an application programming interface (API) exposure system or deployment, such as common API framework (CAPIF).

In an example, a method for UE onboarding with CCF via AF. The method may proceed as follows: receive a request from an application hosted on the UE, where the request comprises one or more descriptions of requested APIs, determine, based on a received request, a first network entity managing the requested APIs (CCF) and a second network entity exposing the requested APIs (AEF); determine to forward the onboarding request to the first network entity in order to enable the UE application access to the requested APIs; and send a response to the UE application. The response may include 1) result of the onboarding request, 2) information identifying the second network entity exposing the requested APIs, or 3) information enabling the UE application to invoke the requested APIs.

In another example, there may be a method for resource owner registration. The method may proceed as follows: determining, based on pre-provisioned information or a message from the UE, that a first UE hosted application provides owner consent for accessing a first API related to the UE or the UE application; and determining to register the UE application as a resource owner with a first network entity in the 5G Core Network or interacting with the 5G Core Network, such that invocation of the first API related to the UE or the UE application results in the UE hosted application being triggered to provide owner consent if triggering corresponding Core Network API(s) related to the UE or the UE application may be desired.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not constrained to limitations that solve any or all disadvantages noted in any part of this disclosure.

### BRIEF DESCRIPTION OF THE DRAWINGS

A more detailed understanding may be had from the following description, given by way of example in conjunction with the accompanying drawings wherein:

FIG. 1 illustrates exemplary CAPIF Functional Model;

FIG. 2 illustrates exemplary Business relationships in SNA;

FIG. 3 illustrates an exemplary method for UE application onboarding with CCF via the AIP;

FIG. 4 illustrates an exemplary method for UE application onboarding directly with CCF;

FIG. 5 illustrates an exemplary method for CCF discovery at PDU Session establishment;

FIG. 6 illustrates an exemplary method for resource owner registration;

FIG. 7 illustrates an exemplary method for obtaining resource owner consent;

FIG. 8 illustrates an exemplary GUI initiating resource owner registration;

FIG. 9 illustrates an exemplary GUI for Resource owner registration configuration;

FIG. 10 illustrates an exemplary GUI for obtaining consent;

FIG. 11A illustrates an example communications system;

FIG. 11B illustrates an exemplary system that includes RANs and core networks;

FIG. 11C illustrates an exemplary system that includes RANs and core networks;

FIG. 11D illustrates an exemplary system that includes RANs and core networks;

FIG. 11E illustrates another example communications system;

FIG. 11F is a block diagram of an example apparatus or device, such as a WTRU; and

FIG. 11G is a block diagram of an exemplary computing system.

### DETAILED DESCRIPTION

In 5G system, network exposure has been provided in the context of CAPIF, which is hosted within the public land mobile network (PLMN) operator network. The system has been designed to provide API exposure to API invokers typically provided by a third-party application provider who has a service agreement with the PLMN operator. The API invoker may reside within the same trust domain as the PLMN operator network and conventionally may be implemented, as an application function (AF). In order to be able to act as API Invokers, AFs onboard with the CAPIF system via the CAPIF Core Function (CCF).

Conventionally, it is not possible for UEs to act as API Invokers in a CAPIF system. However, UE Applications need to be enabled to invoke Northbound APIs with or without using the AF as the API Invoker. For example, a first UE may invoke the location API to discover the location of a second UE.

In order to be able to act as an API Invoker, UE applications may be onboarded with the CCF. Therefore, methods for UEs onboarding with CAPIF are disclosed herein. In addition, the onboarding process may include determining the best CAPIF exposure function (e.g., at the edge). While the onboarding is done with a central CCF, the UE may request to be provided with information based on the most suitable CAPIF deployment available.

Invocation of some northbound APIs may also require obtaining owner consent. In the previous example, when the first UE invokes the location API to determine the location of the second UE, owner consent may be obtained from the second UE. Therefore, methods to obtain owner consent for some API invocations related to specific resources are disclosed herein.

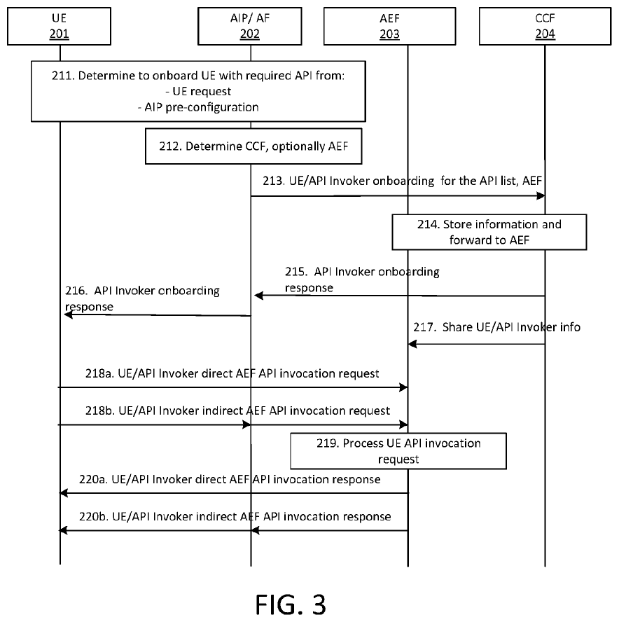

FIG. 3 illustrates an exemplary method for UE application onboarding with CCF via the API Invoker Proxy (AIP). To be enabled to act as API Invokers, UEs 201 may be onboarded in the CAPIF deployment. A procedure for UE onboarding via an AF is disclosed. This procedure may allow CCF 204 to authenticate and authorize UE 201 as an API Invoker as well as to authorize AF to act as an API Invoker on behalf of UE 201. In addition, the procedure allows the onboarding of one or more UE applications as API Invokers.

The role of the AF in this procedure may as an AIP (e.g., AIP 202). ATP 202 may also be described as an API Invoker Management Function, or API Invoker Coordination function, among other things. If AF 202 provides services only on behalf of UE 201, such an AF 202 may be described as a UE Invoker Management Function or the like. This functionality may be implemented as functionality within CCF 204, AEF 203, or AMF 206 (API management function). When not implemented within the CAPIF deployment, (e.g., CCF, AEF) the AIP may also act as API Invoker, e.g. from the perspective of messaging to CCF 204.

In step 211, AIP 202 may determine to trigger UE onboarding an API Invoker with CCF 204. The determination may be done based on a request from UE 201 or based on a pre-configuration available at AIP 202. A combination of the two, as with the “or” statements herein is also contemplated.

A UE request for onboarding provided to AIP 202 includes a list of requested APIs for instantiation. The request may also include the first, second, and third considerations below.

A first consideration may include UE/API Invoker parameters, such as: UE network provider, UE service provider, UE ID (e.g., external ID), group ID, API provider domain, API Invoker OS, API Invoker device (e.g., International Mobile Equipment Identity—IMEI), API Invoker subscription (e.g., IMSI), API Invoker AppID, API Invoker userID, API Invoker supported features, resource owner IDs for API Invocations, permission for AIP to act as API Invoker on its behalf, or credentials for API invocations.

A second consideration may include conditions for determining the targeted CCF 204 or API exposing functions of interest, such as: targeted location for the instantiation, or targeted location for the path coverage, targeted network conditions (e.g., congestion status), preferred PLMN, preferred roaming status, preferred slice information, or preferred API provider domain. These conditions may include an indicator of whether UE 201 wants (e.g., requests) to be updated with information about targeted CCF 204 or AEF 203, if they change, i.e., dynamic CAPIF discovery indicator and whether UE 201 is interested in being onboarded to multiple CCFs 204. Exposing an API is generally offering an access to services (e.g., information or logic) through an interface (e.g., the API), with full control of what is shown or not.

The AF (e.g., AIP 202) may use any other available information for determining CCF 204. For example, the AF may use the resource owner IDs for API Invocations which are part of the UE/API Invoker parameters group in the onboarding request. This information may be used to determine CCF 204 with AEFs 203 that may be used to perform operations on the UE requested resources. This information may also be provided using UE IDs, API Invoker userIDs, AF identifiers or application identifiers, which can be used to map to resources and resource owners corresponding to the requested APIs.

Note that UE 201 may determine (e.g., discover) the target CCF using methods described herein. If CCF 204 is already known by UE 201, the CCF information may be provided in this list directly.

A third consideration may include API Invoker context, such as UE location, time, registered PLMN, slice information (e.g., requested, allowed), network condition (e.g., congestion status, QoS), or roaming status.

Note that a separate onboarding procedure of AIP 202 with CCF 204 may occur before this procedure. In that case, such an AF onboarding procedure may enable AIP 202 to be an API Invoker on its own behalf and an indication may have been provided to inform CCF 204 of the AF support of AIP functionality. For example, the AF may call the CAPIF_API_Invoker_Management_API and instead of providing a list of APIs for enrollment, AIP 202 may include an indication to specify AIP 202 supports API invoker proxy functionality. This procedure enables the AF to also be an API Invoker on behalf of the onboarded UE application.

In response to the indication, CCF 204 may return a list of service API information of AEFs that are registered with CCF 204 along with a status that AIP 202 may serve as an API invoker proxy. Included in the service API information may be AEF instance information specifying the AEF instance identifier, contact information, or service APIs the AEF 203 supports, among other things. AIP 202 may use the service API information of the various AEFs 203 to discover charging information associated with the APIs 202 each AEF 203 supports. The charging information may include the charging rates, usage periods, supported API Invoker user levels, coverage areas, QoS levels, or APIs tier levels (e.g., included at a charging rate and for a usage period), among other things.

In step 212, if permission for AIP 202 to act as API Invoker on behalf of UE 201 has been provided, AIP 202 stores the UE's credentials for future API invocations.

In this step 212, AIP 202 determines CCF 204 (or the AEF 203) exposing the requested APIs. AIP 202 may use the conditions for determining the targeted CCF or API exposing functions of interest provided in the request, using pre-provisioned information, or information AIP 202 obtained from the response CCF 204 provided when granting ATP 202 the API invoker proxy functionality.

If the dynamic CAPIF discovery indicator is included in the step 211 request, AIP 202 determines, based on the request, pre-provisioned information, or information ATP 202 obtained from CCF 204, whether it may be capable of selecting other CCFs to which UE 201 may be onboarded, should the API Invoker context change. In other words, whether it has whether it has the CAPIF deployment information and logic necessary to determine other CCFs. If it is capable of selecting other CCFs 204, AIP 202 sets up periodic or event-based monitoring of UE context, e.g., location, network conditions, etc. When the conditions result in a different CCF being necessary to onboard UE 201, AIP 202 may trigger offboarding with the initial CCF and onboarding with the new CCF. In the event of change of CCF 204, AIP 202 may notify UE 201. While the procedure is not fully detailed in the figures, a similar procedure may be repeated after offboarding.

If the dynamic CAPIF discovery indicator is included in the step 211 request, and it impacts AEF 203 discovery without CCF 204 change, there are multiple options. In a first option, if CCF 204 has the capability to provide dynamic CAPIF discovery, the indicator may be forwarded to CCF 204. In a second option, if CCF 204 does not have the capability to provide dynamic CAPIF discovery, AIP 202 set up periodic monitoring of UE context. When the conditions result in a different AEF 203 being able to provide the requested APIs, AIP 202 may perform an onboarding update and may provide CCF 204 with the new AEF 203. This may result in repeating this procedure from step 213 with the new information. Independent of dynamic CAPIF discovery capability at AIP 202, a third option may be for AIP 202 to determine different AEFs 203 able to serve UE 201 based on AEF instance information received from CCF 204 during API invoker proxy procedure or other procedures. This condition may also result in performing an onboarding update.

Periodic or event-based monitoring of UE 201 which AIP 202 may perform to provide the dynamic CAPIF discovery may include the following. First, detecting that the requesting UE may no longer be serviced by CCF 204/AEF 203 it is currently onboarded to (e.g., requesting UE has roamed out of service area, CCF/AEF 203 no longer available, etc.). Second, detecting that APIs, resources or resource owners needed by UE 201 invocations cannot be serviced by CCF 204/AEF 203 in which UE 201 is onboarded to.

In step 213, AIP 202 may send an onboarding request to CCF 204. The onboarding request may include all or some of the parameters disclosed in step 211.

Information such as UE 201 parameters or API Invoker parameters may be used by CCF 204 to determine whether to accept the onboarding request. UE 201 parameters or API Invoker parameters may include UE network providers, service providers, UE IDs (e.g., external IDs), group ID, API provider domain, API Invoker OSes, API Invoker devices (e.g., IMEI), API Invoker subscriptions (e.g., GPSI or International Mobile Subscriber Identifier—IMSI), API Invoker AppIDs, API Invoker userIDs, API Invoker supported features, resource owner IDs for API Invocations, permission for AIP to act as API Invoker on its behalf, or credentials for API invocations. AIP 202 may onboard a group of UEs by including a group ID, if CCF 204 is able to associate the group of UEs 201 with the group ID. AIP 202 may include both a group ID and a list of UE IDs to onboard the group of UEs. In addition, AIP 202 may onboard UE 201 to multiple CCFs 204 transparently based on its own determination or if UE 201 indicated the option in the request from step 211.

AIP 202 may include, in step 213, information about AEF 202 that was determined in step 212 to provide the list of APIs required by the UE(s) 201. Otherwise, AIP 202 may provide to CCF 204 the list of APIs that UE(s) 201 intends to invoke while onboarded. AIP 202 may include its own notification destination to be notified of the onboarding request result.

If not already onboarded, AIP 202 may include its own onboarding information. If already onboarded, AIP 202 may include its own CAPIF ID provided during the onboarding procedure.

If the permission for AIP 202 to act as API Invoker on the behalf of the UE application has been provided in an initial request, AIP 202 may include the list of APIs requested by the UE application(s) with the list of service APIs being requested. If AIP 202 is already onboarded, this may result in a service operation updating its API Invoker onboarding information available at CCF 204.

AIP 202 may include in step 213 information regarding a designated entity that may be charged for APIs that are invoked by UE(s) 201. The designated entities may be UE(s) 201 themselves, AIP 202, or another entity in the system.

In step 214, CCF 204 may first authenticate UE 201/API Invoker(s) and may authorize whether they are permitted to onboard to CCF 204. This may be done using the information provided in step 213. If successfully authenticated and authorized, CCF 204 may onboard UE 201/API Invoker(s) and may store the information provided in step 213 and make it available to AEF 202.

Information such as UE 201/API Invoker parameters, as well as API Invoker context (e.g., UE location, time, registered PLMN, slice information (e.g., requested, allowed), network condition (e.g., congestion status, QoS), or roaming status) may be used for access control by the enforcing entity (e.g., AEF 203). UE 201 parameters, in which UE may be an API Invoker, may include UE network or service providers, UE IDs (e.g., external IDs), group ID, API provider domain, API Invoker OSes, API Invoker devices (e.g., IMEI), API Invoker subscriptions (e.g., IMSI), API Invoker AppIDs, API Invoker userIDs, API Invoker supported features, resource owner IDs for API Invocations, permission for AIP to act as API Invoker on its behalf, or credentials for API invocations.

Note that the information maintained at each of the nodes depends on architectural and deployment choices, including on which is the entity enforcing the resource owner consent, on the entity verifying credentials when API Invocations are performed on behalf of different entities, etc.

In step 215 (CCF 204 to AIP 202) or step 216 (AIP 202 to UE 201), notifications (e.g., responses) to the API Invoker onboarding request may be sent by CCF 204 to AIP 202 or by AIP 202 to UE 201. The information provided in the notification may include the result of the onboarding request, information identifying the AEF(s) 203 exposing the requested API and information enabling UE 201 or AIP 202 to invoke the requested APIs, e.g., AEF contact information.

When AIP 202 onboards a group of UEs, CCF 204 may return an additional identifier in addition to the CAPIF identifier information. The additional identifier may be associated with a group of UEs 201 and be used by AEF 203 to authenticate the group of UEs 201 in certain deployments. For example, the identifier may be used to associate with the group of UEs 201 that is managed by AIP 202 making the API calls. The identifier may be used to allow UEs 201 within the group to access service APIs and charging information may be generated towards a UE 201 or AF that is responsible for the group. As a result, AEF 202 may not need to continuously check the access control policy for every UE 201 within the group. As an example, CCF 204 may indicate in the access control policy response to AEF 202 that AEF 202 may grant access to service APIs where the API invoker provides the identity associated with a group of UEs 201 for a threshold number of accesses before being triggered to make another request to check on the access control policy. AEF 202 may provide enhanced logging information in which both the identifier for the group of UEs 201 and UE 201 CAPIF identifier are provided to CCF 204.

In step 217, CCF 204 may share information provided in step 213 with one or more AEF 203 providing APIs required by UE 201. Using this information, AEF 202 may be able to process UE API invocation requests issued directly from UE API Invoker(s) or requests issued indirectly from AIP 202 on behalf of UE API Invokers.

In step 218a and step 218b, AEF 202 may receive a UE API Invocation request directly from a UE 201 or indirectly via AIP 202.

In step 219, AEF 202 may process UE API Invocation request using the information provided in step 217. AEF 202 authenticates or authorizes the UE API invoker and if successful processes the API invocation request.

In step 220a and step 220b, AEF 202 may provide an API invocation notification (e.g., response) to the UE API Invoker directly or indirectly via ATP 202.

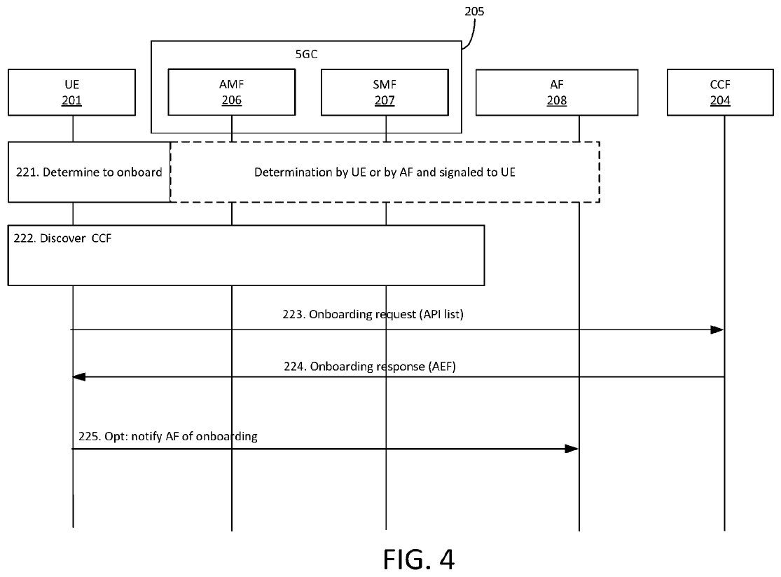

FIG. 4 illustrates exemplary UE application onboarding directly with CCF 204. In step 221, a determination to onboard UE 201 may be made. The determination may be done at the UE 201 (e.g., when CAPIF functionality is triggered). The determination may also be done by an AF communicating with UE 201, based on the UE supported features and services.

In step 222, CCF 204 discovery may be performed. CCF 204 may be determined based on information pre-provisioned at UE 201 or AF 208. Alternatives for the CCF discovery procedure are disclosed herein.

In step 223, UE 201 may send an onboarding notification (e.g., request) to CCF 204 and in step 224, UE 201 may obtain a response. The messages described regarding step 211 and step 215, or step 212 and step 214, in the onboarding procedure via the AF method of FIG. 3, may be used for this procedure as well.

In step 225, UE 201 may provide a notification to AF 208 with the CCF information. The notification may include, for example, permission for AF 208 (as AIP 202) to act as API Invoker on behalf of UE 201, credentials for API invocations, dynamic CAPIF discovery indicator, as well as information (e.g., profile) of CCF 204, in which UE 201 is onboarded with.

If permission for AF 208 (as AIP 202) to act as API Invoker on behalf of UE 201 and credentials for API invocations, AF 208 may separately onboard with CCF 204 and thereafter act as API Invoker on behalf of UE 201, as described herein.

If the dynamic CAPIF discovery indicator is provided, AF 208 (as AIP 202) may proceed to perform AEF discovery on behalf of UE 201, as described earlier. In the event of change of CCF 204, the UE application may directly onboard with the new CCF or onboard via AF 208 (as AIP 202) as described with regard to onboarding with CCF 204 via AF 208.

UE discovery of CCF. UE enablement in CAPIF may rely on the entities in the deployment being able to detect each other and detect the services being offered. The UE onboarding procedure allows CCF 204 to become aware of the UEs 201 available in the deployment. To be able to perform direct onboarding with CCF 204, UE 201 needs to discover which CCF 204 may provide the required services and the corresponding CCF contact information. A CCF profile may be used across CAPIF deployments to enable use cases with more than one CAPIF domain deployed, e.g., with more than one CCF deployment.

The CCF Profile may include the following information. A first information may be a communication interface description which may include one or more of: FQDN, IP address, port, description of the security methods necessary for communication (e.g., PSK, OAUTH, etc.), or protocols supported, among other things. Second information may be a deployment description which may include one or more of: a unique CCF ID, domain name, physical location (e.g., civic, geographical or data center ID), associated PLMNs, physical area of service, or topological area of service, among other things. Third information may include a supported features profile which may include one or more of: descriptions or categories of supported APIs, published APIs, or dynamic CAPIF discovery support, among other things.

While in many deployments CCF profiles may be pre-provisioned at AFs 208 or UEs, discovery procedures for deployments with multiple CAPIF provider domains are disclosed herein.

In a first method, CCF 204 may be discovered by UEs 201 during registration in the serving PLMN. The following may be an enhancement to the General Registration Procedure described in 3GPP 23.502 section 4.2.2.2.2. UE 201 initiates the Registration procedure using registration type “Initial Registration” or “Mobility Registration Update” and requests to retrieve CAPIF information by providing a new CAPIF Configuration Request indication and additional information that indicates that UE 201 wants to access to CAPIF services. The additional information may include Application Descriptors (OSId and OSAppId(s)). The CAPIF information indication may be forward to AMF 206 and to the Policy Control Function (PCF). The PCF 184 may use this information to determine which URSP rules to forward to UE 201. The PCF may respond to the AMF 206 with an indication of whether or not the UE 201 can be configured with URSP rules that will enable access to one or more CCF 204. This indication may be provided by the PCF per Application Descriptor. The indication from the PCF maybe provided to the UE 201, by the AMF 206. The PCF may further subscribe to the AMF 206 to receive notifications when the UE's location changes so that the UE's URSP Rules that relate to edge computing can be updated.

Using a second, alternative method, CCF 204 may be discovered during the PDU Session establishment procedure, by including the disclosed CAPIF configuration request indication.

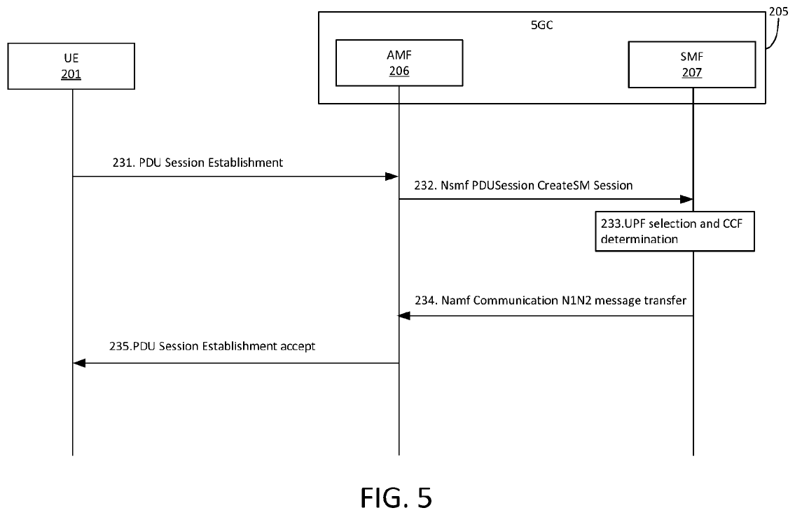

FIG. 5 shows details of the procedure using the PDU Session establishment request as described in TS 23.502 clause 4.3.2.2.1 (the changes to the procedure introduced by this disclosure are detailed, other steps may be executed according to the specification).

In step 231, UE 201 may send to AMF 206 a NAS message (e.g., S-NSSAI(s), DNN, PDU Session ID, Request type, Old PDU Session ID, N1 SM container (PDU Session Establishment Request)), including a new CAPIF Configuration Request indication. The inclusion of the CAPIF Configuration Request indication may indicate that the PDU session may be used for the purpose of communicating with CCF 204, or that CCF information is requested.

In step 232, AMF 206 may proceed to SMF 207 selection and sends Nsmf_PDUSession_CreateSMContext Request to the selected SMF 207 with a flag new CAPIF Configuration Selection Mode flag to SMF 207.

In step 233, SMF 207 may select the UPF and it also determines CCFs 204 available. SMF 207 makes this determination also using UE subscription information from the PCF (as described in the TS 23.502 procedure but not shown in the figure), SMF 207 may also determine what DNS Server Addresses to provide to UE 201 so that an FQDN may be resolved to the IP Address of the operator's CCF, or it may provide the address in the CCF Profile.

In step 234, SMF 207 may send Nsmf_PDUSession_CreateSMContext Response to AMF 206. The response includes one or more sets of CCF information, e.g., CCF interface information or the CCF Profile

In step 235, the PDU Session Establishment messages may provide the requested CAPIF information to UE 201.

A third alternative for CCF discovery is using the UE onboarding request described in step 211 of the onboarding via AF procedure depicted in FIG. 3. If UE 201 wants to determine CCF 204 on its own, the request may contain initially a “CCF discovery only flag.” This results in AIP 202 providing UE 201 with the CCF Profile information it has been pre-configured with. Following the discovery of the CCF information from AIP 202, UE 201 may proceed with an onboarding request with the desired configuration.

As described in 3GPP TR 23.700-95 (v.1.0.0) clause 4.3 API invocation in the context of CAPIF may require owner consent.

Management of resource owners is disclosed herein. The term “resource” may refer to physical entities such as devices (e.g., UE), or to non-physical entities such as data or information. The term “owner” may refer to a computing device, that may be controlled by an entity, such as any stakeholder which is enabled by the API provider to provide consent for API invocation involving specific resources. The owner may be an identified by an electronic user profile or electronic identifier associated with a company, individual, or a device. Therefore, “user consent” may be referred to as “resource owner consent” or, shorter, “owner consent”. “Resource owner” refers to a user profile that can grant access to a protected resource. Protected resources can comprise information, applications or devices. Resources and the user profile corresponding to their owner may reside on the same device, different devices or on network servers.

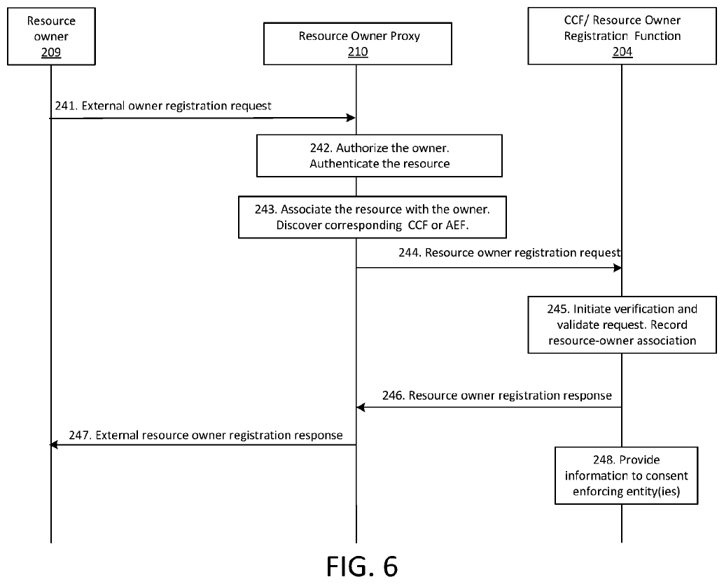

To enable resource owner consent in the context of CAPIF API invocation, a resource owner registration procedure is disclosed. FIG. 6 illustrates an exemplary method for resource owner registration.

In the context of a CAPIF deployment, it may be helpful for the resource owner registration to be directed to an AF acting as a resource owner proxy (ROP) 210 that may link external identifiers to identities and parameters used in the CAPIF deployment, e.g., a mobile network subscription. ROP 210 may also be described as a resource owner management function or resource owner coordination function, among other things. Alternatively, if the system recognizes only a limited number of resources or resource owner type, it (ROP 210) may be referred to in relationship to those types. For example, if UEs 201 are the only resource type recognized, and 3GPP subscribers are the only resource owner types, ROP 210 may be recognized as a 3GPP subscriber function corresponding to a UE. Each UE may have a 3GPP subscription. In this example, ROP 210 may also be an exposure function for exiting 3GPP functionality, such as UDM/UDR. In many deployments, such as those targeting Massive IoT (but not limited to this deployment type) the ROP functionality may be provided by the same server as the AIP functionality.

In step 241, owner 209 (e.g., UE 201 or other device) may send a resource owner registration request to ROP 210 (e.g., UE 201 or another device). The registration request may provide information about the resource owner 209, as well as of the resource being registered. The registration request may include one or more resource identifiers, one or more identifiers of owner 209 (e.g., associated electronic user profile or electronic identifier), one or more application identifiers (AppID), one or more identifiers for APIs requiring consent, one or more consent triggering allowed conditions, one or more contact addresses for targeting owner consent requests, whether the registration request can be for multiple CCFs, or a registration profile, among other things.

Note that in the absence of unique external identifiers, any of the identifiers in the request may be substituted by or augmented with a corresponding description, information element, or profile.

The disclosed identifiers, such as owner identifier, application identifier, resource identifier, or API identifiers, may also be provided as group identifiers. This may enable, for example, the registration of: an entire group of UEs 201 that the AF 208 manages as resources, or of a group of electronically identified individuals as resource owners, among other things.

The AppID may indicate which application may be used to provide the owner consent. The AppID application may be the same, or different, than the application used to authenticate user A and user B, in which case another AppID for the authentication application may be provided.

As an example, UE 201 is a resource identified by IMEI. Individual users may be identified by the triple (subscription, application, user), such as IMSI, AppID, or userID. Two different users may be registered as owners of the resource using the same subscription (e.g., IMSI) and application (e.g., AppID-X) but with two different user IDs, such as userID A and userID B, therefore using two different triples. In this example, the API associated with the resource may be the 5G system location API. Using this request, user A and user B may be enabled to independently provide consent (via AppID application) for the use of the location API for this UE. The information for obtaining API invocation consent may include information identifying a resource owner or an information of verification and validation of owner consent required for an invocation of the API invoked by the UE application

Consent triggering allowed conditions may include conditions applying to invokers of APIs targeting the resource, as well as conditions applying to the resource. For these conditions, triggering of the procedure to obtain the owner consent in the API Invocation phase is allowed. The registration request may include conditions where the API request may not be granted, with no need for triggering the procedure for obtaining owner consent. The registration procedure may include information about conditions where owner consent may not be triggered and permission for the API request may be granted, e.g., a list of API Invoker identities for which resource owner consent is granted in advance. For example, this may be utilized for cases where a temporary gaming session is configured for a group of users and the request configures owner consent for users of the group to minimize owner consent signaling. The registration request may also include conditions under which consent is revoked, by triggering the procedure to obtain consent (which will then be denied) or by automatically denying API Invocations previously allowed. For example, a timer for expiration of previously provided consent may be provided.

Consent triggering conditions applying to the API invokers may include: API Invoker location, API Invoker network or service provider, API Invoker API provider domain, API Invoker OS, API Invoker device (e.g., IMEI), API Invoker subscription (e.g., IMSI), API Invoker AppID, API Invoker userID, API Invoker supported features, API Invoker network conditions (e.g., congestion status, required QoS), API Invoker roaming status, or API Invoker slice information. Conditions applying to the resource may include: network conditions at the resource (e.g., congestion status, required QoS), resource registration or roaming status, resource slice information, resource location, or time of day, among other things.

Registration profile may include any context at the time of issuing the registration request, e.g., UE location, speed, registration VPLMN, or time of day.

Resource owner 209 (e.g., UE 201 being identified as being a resource owner 209) may send an indication to ROP 210 if the resource registration request may be sent to multiple CCFs 204. In the case that resource owner 209 knows of the CCFs identifiers, the request may include a list of CCFs 204 for which the registration request may be sent to. For security purposes, a resource owner/user profile may be uniquely associated with the device hosting the user profile.

In step 242, resource owner 209 may be authorized by ROP 210 or indicate the resource information is authenticated. Based on step 242, the resource (e.g., UE 201) and owner 209 (e.g., UE 201) may be able to be identified uniquely in the CAPIF system. For simplicity, it may be assumed that ROP 210 may provide a unique ownerID for the owner and a unique resourceID for the resource, where the IDs are unique within the CAPIF deployment. Elements of the registration profile may be used together with the identifiers provided in the registration request to ensure uniqueness of the assigned identifiers. The ownerID and resourceID may be substituted by unique descriptions or profiles, the identifiers in the registration request may be reused, or the ownerID and resourceID may both identify the same entity (e.g., UE 201 or another device), among other things.

The authentication, authorization and ID assignment parts of step 242 may be executed prior to the resource owner registration request, e.g., via pre-provisioning at ROP 210 or via separate discovery or publishing steps. For example, ROP 210 may be provided with a list of UEs 201 it interacts with in the context of CAPIF, e.g., a list of IMEI. Similarly, the list of APIs requiring consent may be pre-provisioned to ROP 210.

In step 243, ROP 210 may use the provided information, ownerID, resourceID provided (e.g., allocated), or links the owner to the resources owned. The remaining registration information (e.g., the API identifiers, service conditions, consent triggering conditions) may be stored and associated. ROP 210 may discover the applicable CCF 204 (also referred here as Resource Owner Registration Handling Function) or AEF 203. In FIG. 6, the Resource Owner Registration Handling Function and CCF 204 are depicted together, as they may be collocated, but independent implementations are possible. The Resource Owner Registration Handling Function may be implemented as functionality within the API management function. The discovery of any CAPIF entities (e.g., CCF 204, AEF 203, etc.) in this step may use information in the registration profile (e.g., anticipated UE location), as well as the list of APIs requiring consent, to discover AEF 203.

In step 244 a resource owner registration request may be sent to CCF 204. At step 245, the resource owner registration handling function by ROP 210 may be validated and stored at CCF 204. At step 246, a response may be sent to ROP 210. The information sent in the resource owner registration request in step 244 may include all or some of the information elements disclosed for step 241, such as one or more resource identifiers, one or more identifiers of the owner, one or more application identifiers, one or more identifiers for APIs requiring consent, one or more consent triggering allowed conditions, one or more contact addresses for targeting owner consent, or a registration profile, among other things.

The identifiers may be replaced with or augmented by CAPIF identifiers determined by ROP 210 in step 242 or step 243. Information related to ROP 210 (e.g., its ID as API Invoker) and any discovered AEFs 203 may be included.

If an indicator is provided to indicate the registration request may be targeted to multiple CCFs 204 in step 241, ROP 210 may send individual registration requests to different CCFs 204.

In step 247, the response is sent by ROP 210 to the resource owner. Note that when the Resource Owner Management Handling Function is co-located with CCF 204, the AEF discovery described in step 243 may instead be conducted by CCF 204 in step 245. In that case, the registration response in step 246 may provide the result of the discovery to ROP 210.

Note that step 245 may involve function calls to other 5GC entities, e.g., to PCF over the N30 reference point, UDR over the N37 reference point, etc. This may allow CCF 204 or the resource registration handling function access to network-specific identifiers and subscription information for the owner and resource. Resource owner management handling function, resource registration handling function, resource Owner Handling Function, authorization function, handling function, or the like referred herein may be used interchangeably.

In step 248, CCF 204 may send the information to the owner consent enforcement entities, e.g., AEFs 203. Step 248 may also include function calls to other 5GC entities. AEF 203 may use information provided in step 244 and forwarded in step 248 (e.g., consent triggering allowed conditions) to determine when to trigger the consent request API or when triggering of this API is not allowed. It also uses the AppID determining which application may be used to request and receive consent and therefore to determine which API to use for this purpose.

Note the disclosed resource owner registration request may be sent by resource owner 209 directly to CCF 204/resource registration handling function, in which case the functionality provided by ROP 210 may be implemented in the CCF 204/resource registration handling function. In that case, the resource owner may be co-located with an already onboarded API Invoker, that may discover CCF 204. For UEs, the UE application onboarding procedure (e.g., FIG. 3 or FIG. 4) also described in this disclosure may apply.

A deployment that includes ROP 210 may have the advantage of enlarging the scope of devices allowable in the system. For example, the external registration may be performed for a Personal IoT Network device (e.g., wearable device).

UE owner registration may be provided for CAPIF APIs which do not expose 5GC services but may be managed using the same CAPIF deployment that includes exposure of 5GC service APIs. Also, a UE owner registration may be provided so that the 5GC subscription information is used for owner consent, even if the device is used without 5GC service.

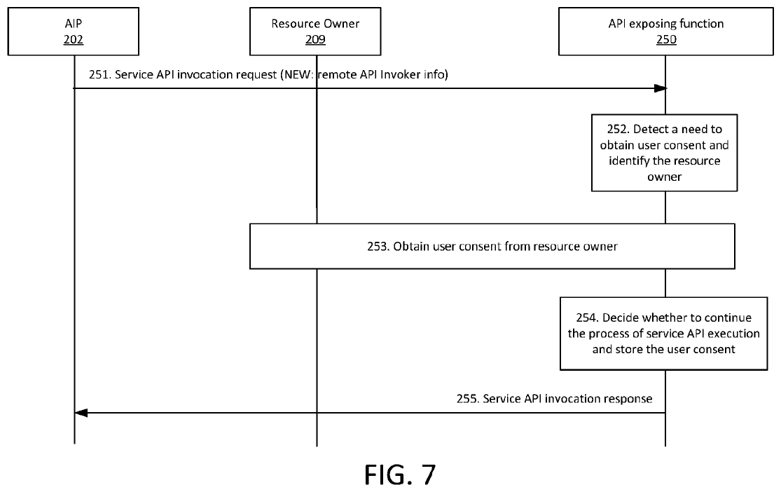

Obtaining owner consent is disclosed below. After execution of the disclosed owner registration request, the procedure for obtaining owner consent from the resource owner may be executed as shown in FIG. 7, assuming that AEF 203 is the consent enforcing entity. Note that in order for AEF 203 to execute step 252 and determine the need to obtain resource owner consent upon a service API invocation request, the triggering conditions disclosed in the owner registration request may be required.

Note also that the disclosed procedures may allow the service API Invocation in step 251 to be triggered by UEs 201 and by AFs 208 on behalf of UEs 201, in addition to being triggered by AFs 208 (on their own behalf).

For cases where AIP 202 acts as API Invoker on behalf of a remote API Invoker (e.g., UE 201 or AF 208), additional information about the remote API Invoker may be included in step 251. The additional remote API Invoker information may include: an indicator that the API invocation is performed on behalf of a remote API Invoker, or identity (e.g., credentials) of the remote API Invoker on whose behalf the AIP 202 is performing the invocation. Alternatively, AIP 202 may include its own identity and credentials, an indicator of performing on behalf of a remote AIP Invoker, and the identity of the remote API Invoker. In yet another example, owner consent may be obtained such that AIP 202 may be trusted to perform API invocation for entire classes of API Invokers (e.g., a UE group identified by Group ID, for all or some of the API Invokers served by AIP 202, for all or some of the UEs in a specific region, with specific capabilities or characteristics, etc.). In the latter case, the remote API invoker information may indicate only that the remote API Invoker belongs to the trusted API Invokers class.

At step 253, user consent may be obtained from resource owner 209. AEF may send to the Resource Owner a request identifying the resource attempted to be accessed, the API invoker, as well as context for the attempted API invocation, e.g. consent triggering allowed conditions. At step 254, determine whether to continue the process of service API execution (e.g., whether the API Invocation was granted) and trigger the execution. The user consent may be stored as well. The user consent may be stored as well. At step 255, service API invocation response may be sent. The response may include information on whether the procedure for obtaining user consent was triggered and its result, whether the service API invocation was executed and its results, API invocation context at the AEF, etc.

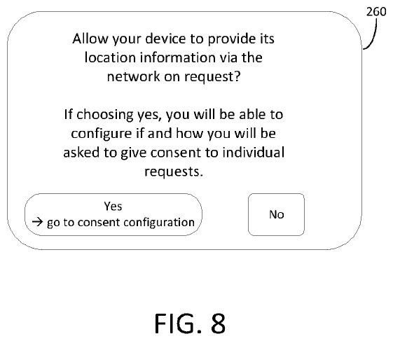

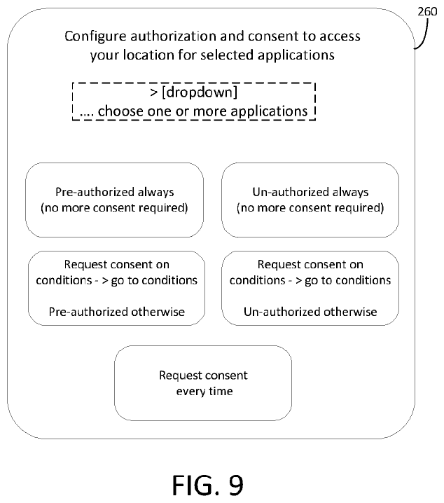

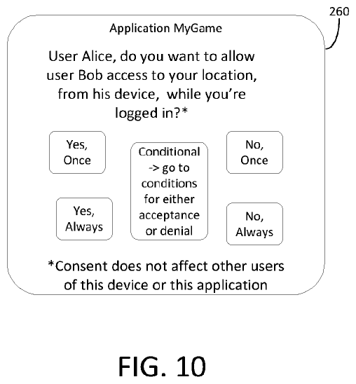

An exemplary API used by a mobile device (e.g., UE 201) to determine whether a resource owner registration request may be triggered from the UE 201 is shown in FIG. 8. FIG. 8 illustrates an exemplary graphical user interface (GUI) that may have a display 260 associated with initiating resource owner registration, at some time t0. A GUI, as shown in FIG. 9, that has display 260 may indicate, at some time t1, additional parameters for the resource owner registration. Another example of functionality enabled is depicted in FIG. 10. In FIG. 10, display 260 may provide, at some time t2, an indication regarding obtaining consent. One of a plurality of options of display 260 (e.g., FIG. 8, FIG. 9, or FIG. 10) may be chosen.

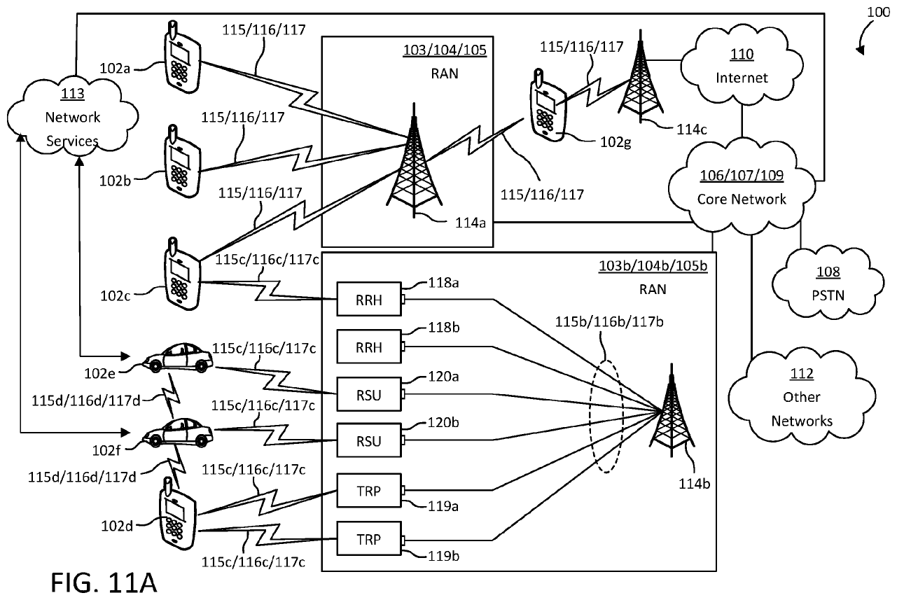

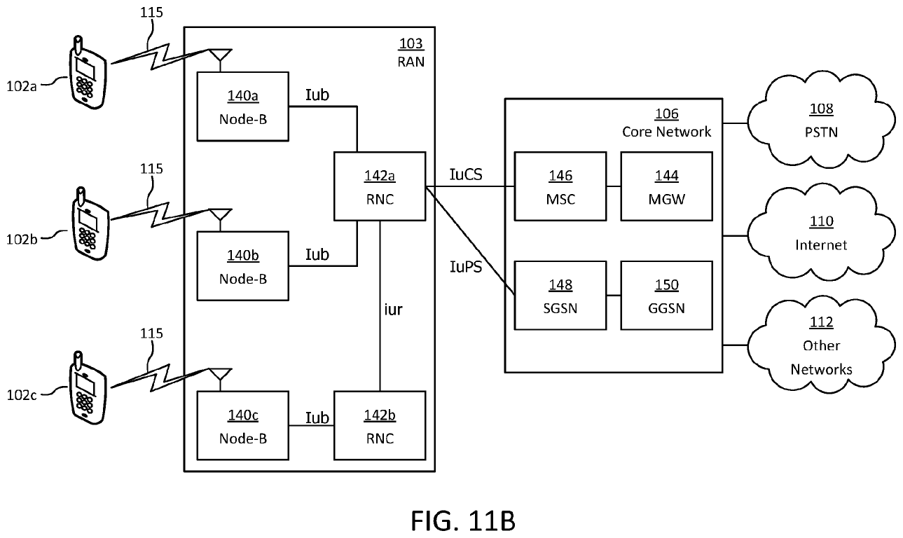

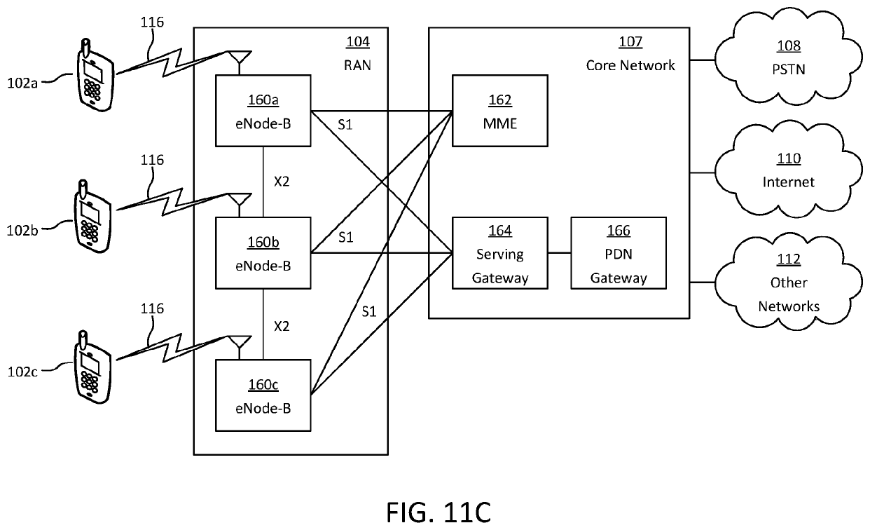

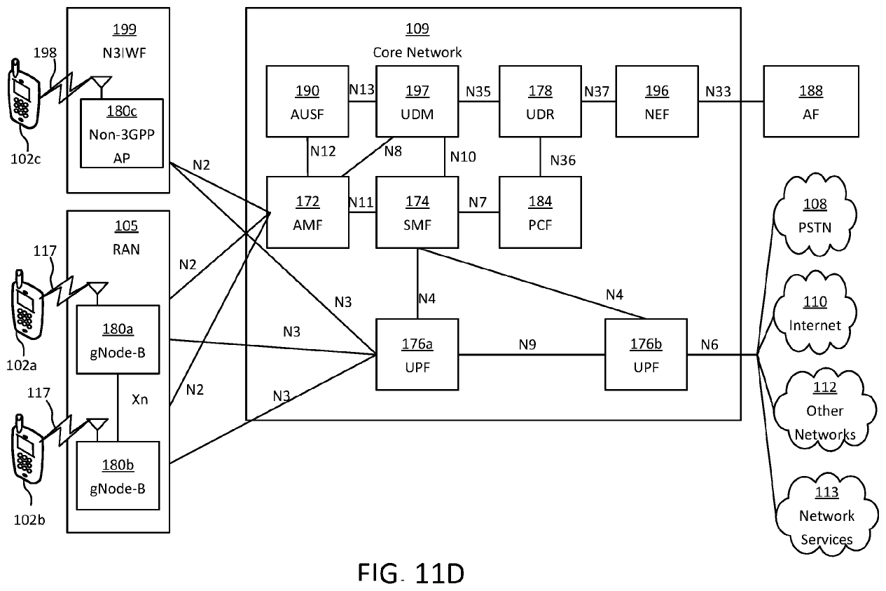

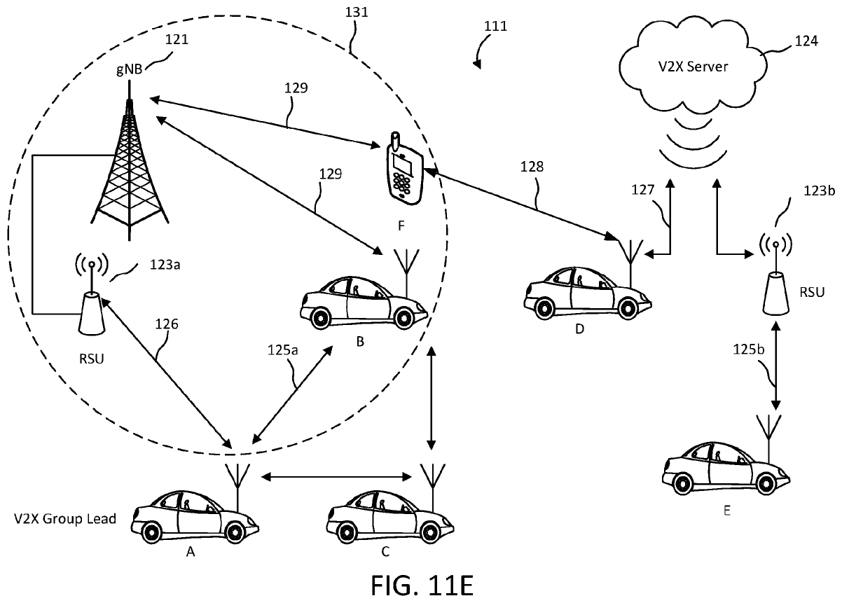

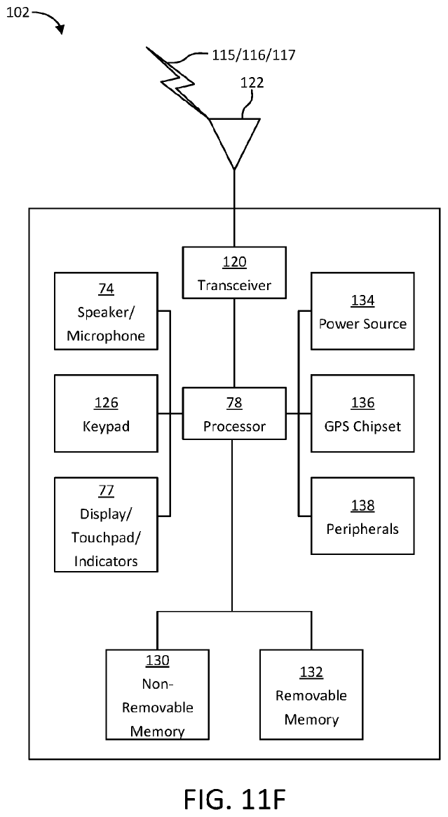

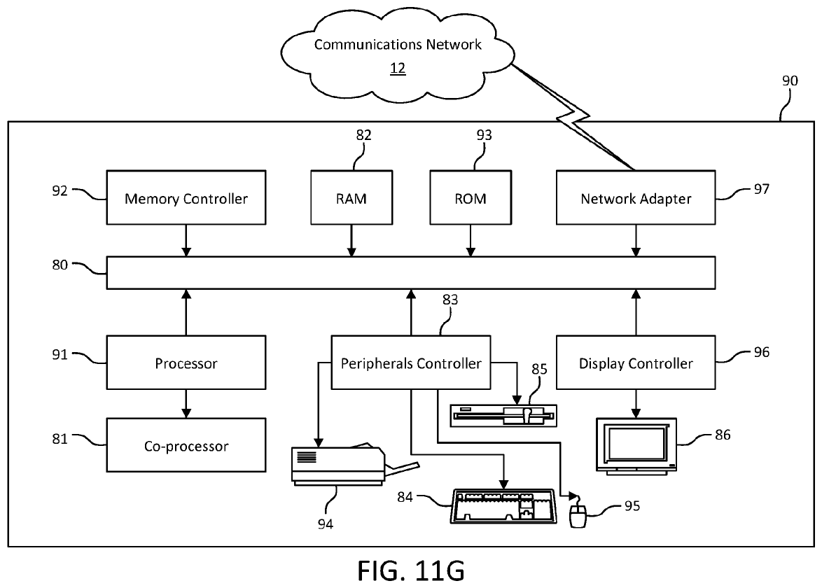

It is understood that the entities performing the steps illustrated herein, such as FIG. 3-FIG. 10, may be logical entities. The steps may be stored in a memory of, and executing on a processor of, a device, server, or computer system such as those illustrated in FIG. 11F or FIG. 11G. Skipping steps, combining steps, or adding steps between exemplary methods disclosed herein (e.g., FIG. 3-FIG. 10) is contemplated. Table 1 provides exemplary abbreviations and definitions.

TABLE 1
Abbreviations and Definitions

| Abbreviations | Definitions |
|---|---|
| 3GPP | 3rd Generation Partnership Program |
| AEF | API Exposure Function |
| AF | Application Function |
| API | Application Program Interface |
| App ID | Application Identifier |
| AS | Application Server |
| CAPIF | Common API Framework |
| CCF | CAPIF Core Function |
| GPSI | Generic Public Subscription Identifier |
| IP | Internet Protocol |
| MNO | Mobile Network Operator |
| NEF | Network Exposure Function |
| OS | Operating System |
| PLMN | Public Land Mobile Network |
| SCEF | Service Capability Exposure Function |
| SNA | Subscriber-aware Northbound API access |
| UDM | Unified Data Manager |
| UDR | Unified Data Repository |
| UE | User Equipment |

The 3rd Generation Partnership Project (3GPP) develops technical standards for cellular telecommunications network technologies, including radio access, the core transport network, and service capabilities—including work on codecs, security, and quality of service. Recent radio access technology (RAT) standards include WCDMA (commonly referred as 3G), LTE (commonly referred as 4G), LTE-Advanced standards, and New Radio (NR), which is also referred to as “5G”. 3GPP NR standards development is expected to continue and include the definition of next generation radio access technology (new RAT), which is expected to include the provision of new flexible radio access below 7 GHz, and the provision of new ultra-mobile broadband radio access above 7 GHz. The flexible radio access is expected to consist of a new, non-backwards compatible radio access in new spectrum below 6 GHz, and it is expected to include different operating modes that may be multiplexed together in the same spectrum to address a broad set of 3GPP NR use cases with diverging requirements. The ultra-mobile broadband is expected to include cmWave and mmWave spectrum that will provide the opportunity for ultra-mobile broadband access for, e.g., indoor applications and hotspots. In particular, the ultra-mobile broadband is expected to share a common design framework with the flexible radio access below 7 GHz, with cmWave and mmWave specific design optimizations.

3GPP has identified a variety of use cases that NR is expected to support, resulting in a wide variety of user experience requirements for data rate, latency, and mobility. The use cases include the following general categories: enhanced mobile broadband (eMBB) ultra-reliable low-latency Communication (URLLC), Non-Terrestrial Networks (NTN), massive machine type communications (mMTC), network operation (e.g., network slicing, routing, migration and interworking, energy savings), and enhanced vehicle-to-everything (eV2X) communications, which may include any of Vehicle-to-Vehicle Communication (V2V), Vehicle-to-Infrastructure Communication (V2I), Vehicle-to-Network Communication (V2N), Vehicle-to-Pedestrian Communication (V2P), and vehicle communications with other entities. Specific service and applications in these categories include, e.g., monitoring and sensor networks, device remote controlling, bi-directional remote controlling, personal cloud computing, video streaming, wireless cloud-based office, first responder connectivity, automotive ecall, disaster alerts, real-time gaming, multi-person video calls, autonomous driving, augmented reality, tactile internet, virtual reality, home automation, robotics, and aerial drones to name a few. All of these use cases and others are contemplated herein.

FIG. 11A illustrates an example communications system 100 in which the methods and apparatuses of enablement of CAPIF API invocation by UE applications, such as the systems and methods illustrated in FIG. 3 through FIG. 10 described and claimed herein may be used. The communications system 100 may include wireless transmit/receive units (WTRUs) 102a, 102b, 102c, 102d, 102e, 102f, or 102g (which generally or collectively may be referred to as WTRU 102 or WTRUs 102). The communications system 100 may include, a radio access network (RAN) 103/104/105/103b/104b/105b, a core network 106/107/109, a public switched telephone network (PSTN) 108, the Internet 110, other networks 112, and Network Services 113. Network Services 113 may include, for example, a V2X server, V2X functions, a ProSe server, ProSe functions, IoT services, video streaming, or edge computing, etc.

It will be appreciated that the concepts disclosed herein may be used with any number of WTRUs, base stations, networks, or network elements. Each of the WTRUs 102a, 102b, 102c, 102d, 102e, 102f, or 102g may be any type of apparatus or device configured to operate or communicate in a wireless environment. Although each WTRU 102a, 102b, 102c, 102d, 102e, 102f, or 102g may be depicted in FIG. 11A, FIG. 11B, FIG. 11C, FIG. 11D, FIG. 11E, or FIG. 11F as a hand-held wireless communications apparatus, it is understood that with the wide variety of use cases contemplated for 5G wireless communications, each WTRU may comprise or be embodied in any type of apparatus or device configured to transmit or receive wireless signals, including, by way of example only, user equipment (UE), a mobile station, a fixed or mobile subscriber unit, a pager, a cellular telephone, a personal digital assistant (PDA), a smartphone, a laptop, a tablet, a netbook, a notebook computer, a personal computer, a wireless sensor, consumer electronics, a wearable device such as a smart watch or smart clothing, a medical or eHealth device, a robot, industrial equipment, a drone, a vehicle such as a car, bus, truck, train, or airplane, and the like.

The communications system 100 may also include a base station 114a and a base station 114b. In the example of FIG. 11A, each base stations 114a and 114b is depicted as a single element. In practice, the base stations 114a and 114b may include any number of interconnected base stations or network elements. Base stations 114a may be any type of device configured to wirelessly interface with at least one of the WTRUs 102a, 102b, and 102c to facilitate access to one or more communication networks, such as the core network 106/107/109, the Internet 110, Network Services 113, or the other networks 112. Similarly, base station 114b may be any type of device configured to wiredly or wirelessly interface with at least one of the Remote Radio Heads (RRHs) 118a, 118b, Transmission and Reception Points (TRPs) 119a, 119b, or Roadside Units (RSUs) 120a and 120b to facilitate access to one or more communication networks, such as the core network 106/107/109, the Internet 110, other networks 112, or Network Services 113. RRHs 118a, 118b may be any type of device configured to wirelessly interface with at least one of the WTRUs 102, e.g., WTRU 102c, to facilitate access to one or more communication networks, such as the core network 106/107/109, the Internet 110, Network Services 113, or other networks 112

TRPs 119a, 119b may be any type of device configured to wirelessly interface with at least one of the WTRU 102d, to facilitate access to one or more communication networks, such as the core network 106/107/109, the Internet 110, Network Services 113, or other networks 112. RSUs 120a and 120b may be any type of device configured to wirelessly interface with at least one of the WTRU 102e or 102f, to facilitate access to one or more communication networks, such as the core network 106/107/109, the Internet 110, other networks 112, or Network Services 113. By way of example, the base stations 114a, 114b may be a Base Transceiver Station (BTS), a Node-B, an eNode B, a Home Node B, a Home eNode B, a Next Generation Node-B (gNode B), a satellite, a site controller, an access point (AP), a wireless router, and the like.

The base station 114a may be part of the RAN 103/104/105, which may also include other base stations or network elements (not shown), such as a Base Station Controller (BSC), a Radio Network Controller (RNC), relay nodes, etc. Similarly, the base station 114b may be part of the RAN 103b/104b/105b, which may also include other base stations or network elements (not shown), such as a BSC, a RNC, relay nodes, etc. The base station 114a may be configured to transmit or receive wireless signals within a particular geographic region, which may be referred to as a cell (not shown). Similarly, the base station 114b may be configured to transmit or receive wired or wireless signals within a particular geographic region, which may be referred to as a cell (not shown) for methods, systems, and devices of enablement of CAPIF API invocation by UE applications, as disclosed herein. Similarly, the base station 114b may be configured to transmit or receive wired or wireless signals within a particular geographic region, which may be referred to as a cell (not shown). The cell may further be divided into cell sectors. For example, the cell associated with the base station 114a may be divided into three sectors. Thus, in an example, the base station 114a may include three transceivers, e.g., one for each sector of the cell. In an example, the base station 114a may employ multiple-input multiple output (MIMO) technology and, therefore, may utilize multiple transceivers for each sector of the cell.

The base stations 114a may communicate with one or more of the WTRUs 102a, 102b, 102c, or 102g over an air interface 115/116/117, which may be any suitable wireless communication link (e.g., radio frequency (RF), microwave, infrared (IR), ultraviolet (UV), visible light, cmWave, mmWave, etc.). The air interface 115/116/117 may be established using any suitable radio access technology (RAT).

The base stations 114b may communicate with one or more of the RRHs 118a, 118b, TRPs 119a, 119b, or RSUs 120a, 120b, over a wired or air interface 115b/116b/117b, which may be any suitable wired (e.g., cable, optical fiber, etc.) or wireless communication link (e.g., radio frequency (RF), microwave, infrared (IR), ultraviolet (UV), visible light, cmWave, mmWave, etc.). The air interface 115b/116b/117b may be established using any suitable radio access technology (RAT).

The RRHs 118a, 118b, TRPs 119a, 119b or RSUs 120a, 120b, may communicate with one or more of the WTRUs 102c, 102d, 102e, 102f over an air interface 115c/116c/117c, which may be any suitable wireless communication link (e.g., radio frequency (RF), microwave, infrared (IR), ultraviolet (UV), visible light, cmWave, mmWave, etc.). The air interface 115c/116c/117c may be established using any suitable radio access technology (RAT).

The WTRUs 102a, 102b, 102c, 102d, 102e, or 102f may communicate with one another over an air interface 115d/116d/117d, such as Sidelink communication, which may be any suitable wireless communication link (e.g., radio frequency (RF), microwave, infrared (IR), ultraviolet (UV), visible light, cmWave, mmWave, etc.). The air interface 115d/116d/117d may be established using any suitable radio access technology (RAT).

The communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c, or RRHs 118a, 118b, TRPs 119a, 119b and RSUs 120a, 120b, in the RAN 103b/104b/105b and the WTRUs 102c, 102d, 102e, 102f, may implement a radio technology such as Universal Mobile Telecommunications System (UMTS) Terrestrial Radio Access (UTRA), which may establish the air interface 115/116/117 or 115c/116c/117c respectively using wideband CDMA (WCDMA). WCDMA may include communication protocols such as High-Speed Packet Access (HSPA) or Evolved HSPA (HSPA+). HSPA may include High-Speed Downlink Packet Access (HSDPA) or High-Speed Uplink Packet Access (HSUPA).

In an example, the base station 114a and the WTRUs 102a, 102b, 102c, or RRHs 118a, 118b, TRPs 119a, 119b, or RSUs 120a, 120b in the RAN 103b/104b/105b and the WTRUs 102c, 102d, may implement a radio technology such as Evolved UMTS Terrestrial Radio Access (E-UTRA), which may establish the air interface 115/116/117 or 115c/116c/117c respectively using Long Term Evolution (LTE) or LTE-Advanced (LTE-A). In the future, the air interface 115/116/117 or 115c/116c/117c may implement 3GPP NR technology. The LTE and LTE-A technology may include LTE D2D and V2X technologies and interfaces (such as Sidelink communications, etc.). Similarly, the 3GPP NR technology includes NR V2X technologies and interface (such as Sidelink communications, etc.).

The base station 114a in the RAN 103/104/105 and the WTRUs 102a, 102b, 102c, and 102g or RRHs 118a, 118b, TRPs 119a, 119b or RSUs 120a, 120b in the RAN 103b/104b/105b and the WTRUs 102c, 102d, 102e, 102f may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114c in FIG. 11A may be a wireless router, Home Node B, Home eNode B, or access point, for example, and may utilize any suitable RAT for facilitating wireless connectivity in a localized area, such as a place of business, a home, a vehicle, a train, an aerial, a satellite, a manufactory, a campus, and the like, for implementing the methods, systems, and devices of enablement of CAPIF API invocation by UE applications, as disclosed herein. In an example, the base station 114c and the WTRUs 102, e.g., WTRU 102e, may implement a radio technology such as IEEE 802.11 to establish a wireless local area network (WLAN). similarly, the base station 114c and the WTRUs 102d, may implement a radio technology such as IEEE 802.15 to establish a wireless personal area network (WPAN). In yet another example, the base station 114c and the WTRUs 102, e.g., WTRU 102e, may utilize a cellular-based RAT (e.g., WCDMA, CDMA2000, GSM, LTE, LTE-A, NR, etc.) to establish a picocell or femtocell. As shown in FIG. 11A, the base station 114c may have a direct connection to the Internet 110. Thus, the base station 114c may not be required to access the Internet 110 via the core network 106/107/109.

The RAN 103/104/105 or RAN 103b/104b/105b may be in communication with the core network 106/107/109, which may be any type of network configured to provide voice, data, messaging, authorization and authentication, applications, or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, packet data network connectivity, Ethernet connectivity, video distribution, etc., or perform high-level security functions, such as user authentication.

Although not shown in FIG. 11A, it will be appreciated that the RAN 103/104/105 or RAN 103b/104b/105b or the core network 106/107/109 may be in direct or indirect communication with other RANs that employ the same RAT as the RAN 103/104/105 or RAN 103b/104b/105b or a different RAT. For example, in addition to being connected to the RAN 103/104/105 or RAN 103b/104b/105b, which may be utilizing an E-UTRA radio technology, the core network 106/107/109 may also be in communication with another RAN (not shown) employing a GSM or NR radio technology.

The core network 106/107/109 may also serve as a gateway for the WTRUs 102a, 102b, 102c, 102d, 102e to access the PSTN 108, the Internet 110, or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned or operated by other service providers. For example, the networks 112 may include any type of packet data network (e.g., an IEEE 802.3 Ethernet network) or another core network connected to one or more RANs, which may employ the same RAT as the RAN 103/104/105 or RAN 103b/104b/105b or a different RAT.

Some or all of the WTRUs 102a, 102b, 102c, 102d, 102e, and 102f in the communications system 100 may include multi-mode capabilities, e.g., the WTRUs 102a, 102b, 102c, 102d, 102e, and 102f may include multiple transceivers for communicating with different wireless networks over different wireless links for implementing methods, systems, and devices of enablement of CAPIF API invocation by UE applications, as disclosed herein. For example, the WTRU 102g shown in FIG. 11A may be configured to communicate with the base station 114a, which may employ a cellular-based radio technology, and with the base station 114c, which may employ an IEEE 802 radio technology.

Although not shown in FIG. 11A, it will be appreciated that a User Equipment may make a wired connection to a gateway. The gateway maybe a Residential Gateway (RG). The RG may provide connectivity to a Core Network 106/107/109. It will be appreciated that much of the subject matter included herein may equally apply to UEs that are WTRUs and UEs that use a wired connection to connect with a network. For example, the subject matter that applies to the wireless interfaces 115, 116, 117 and 115c/116c/117c may equally apply to a wired connection.

FIG. 11B is a system diagram of an example RAN 103 and core network 106 that may implement methods, systems, and devices of enablement of CAPIF API invocation by UE applications, as disclosed herein. As noted above, the RAN 103 may employ a UTRA radio technology to communicate with the WTRUs 102a, 102b, and 102c over the air interface 115. The RAN 103 may also be in communication with the core network 106. As shown in FIG. 11B, the RAN 103 may include Node-Bs 140a, 140b, and 140c, which may each include one or more transceivers for communicating with the WTRUs 102a, 102b, and 102c over the air interface 115. The Node-Bs 140a, 140b, and 140c may each be associated with a particular cell (not shown) within the RAN 103. The RAN 103 may also include RNCs 142a, 142b. It will be appreciated that the RAN 103 may include any number of Node-Bs and Radio Network Controllers (RNCs.)

As shown in FIG. 111B, the Node-Bs 140a, 140b may be in communication with the RNC 142a. Additionally, the Node-B 140c may be in communication with the RNC 142b. The Node-Bs 140a, 140b, and 140c may communicate with the respective RNCs 142a and 142b via an Iub interface. The RNCs 142a and 142b may be in communication with one another via an Iur interface. Each of the RNCs 142a and 142b may be configured to control the respective Node-Bs 140a, 140b, and 140c to which it is connected. In addition, each of the RNCs 142a and 142b may be configured to carry out or support other functionality, such as outer loop power control, load control, admission control, packet scheduling, handover control, macro-diversity, security functions, data encryption, and the like.

The core network 106 shown in FIG. 11B may include a media gateway (MGW) 144, a Mobile Switching Center (MSC) 146, a Serving GPRS Support Node (SGSN) 148, or a Gateway GPRS Support Node (GGSN) 150. While each of the foregoing elements are depicted as part of the core network 106, it will be appreciated that any one of these elements may be owned or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, and 102c with access to circuit-switched networks, such as the PSTN 108, to facilitate communications between the WTRUs 102a, 102b, and 102c, and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, and 102c with access to packet-switched networks, such as the Internet 110, to facilitate communications between and the WTRUs 102a, 102b, and 102c, and IP-enabled devices.

The core network 106 may also be connected to the other networks 112, which may include other wired or wireless networks that are owned or operated by other service providers.

FIG. 11C is a system diagram of an example RAN 104 and core network 107 that may implement methods, systems, and devices of enablement of CAPIF API invocation by UE applications, as disclosed herein. As noted above, the RAN 104 may employ an E-UTRA radio technology to communicate with the WTRUs 102a, 102b, and 102c over the air interface 116. The RAN 104 may also be in communication with the core network 107.

The RAN 104 may include eNode-Bs 160a, 160b, and 160c, though it will be appreciated that the RAN 104 may include any number of eNode-Bs. The eNode-Bs 160a, 160b, and 160c may each include one or more transceivers for communicating with the WTRUs 102a, 102b, and 102c over the air interface 116. For example, the eNode-Bs 160a, 160b, and 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink or downlink, and the like. As shown in FIG. 11C, the eNode-Bs 160a, 160b, and 160c may communicate with one another over an X2 interface.

The core network 107 shown in FIG. 11C may include a Mobility Management Gateway (MME) 162, a serving gateway 164, and a Packet Data Network (PDN) gateway 166. While each of the foregoing elements are depicted as part of the core network 107, it will be appreciated that any one of these elements may be owned or operated by an entity other than the core network operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, and 102c, bearer activation/deactivation, selecting a particular serving gateway during an initial attach of the WTRUs 102a, 102b, and 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, and 160c in the RAN 104 via the S1 interface. The serving gateway 164 may generally route and forward user data packets to/from the WTRUs 102a, 102b, and 102c. The serving gateway 164 may also perform other functions, such as anchoring user planes during inter-eNode B handovers, triggering paging when downlink data is available for the WTRUs 102a, 102b, and 102c, managing and storing contexts of the WTRUs 102a, 102b, and 102c, and the like.

The serving gateway 164 may also be connected to the PDN gateway 166, which may provide the WTRUs 102a, 102b, and 102c with access to packet-switched networks, such as the Internet 110, to facilitate communications between the WTRUs 102a, 102b, 102c, and IP-enabled devices.

The core network 107 may facilitate communications with other networks. For example, the core network 107 may provide the WTRUs 102a, 102b, and 102c with access to circuit-switched networks, such as the PSTN 108, to facilitate communications between the WTRUs 102a, 102b, and 102c and traditional land-line communications devices. For example, the core network 107 may include, or may communicate with, an IP gateway (e.g., an IP Multimedia Subsystem (IMS) server) that serves as an interface between the core network 107 and the PSTN 108. In addition, the core network 107 may provide the WTRUs 102a, 102b, and 102c with access to the networks 112, which may include other wired or wireless networks that are owned or operated by other service providers.

FIG. 11D is a system diagram of an example RAN 105 and core network 109 that may implement methods, systems, and devices of enablement of CAPIF API invocation by UE applications, as disclosed herein. The RAN 105 may employ an NR radio technology to communicate with the WTRUs 102a and 102b over the air interface 117. The RAN 105 may also be in communication with the core network 109. A Non-3GPP Interworking Function (N3IWF) 199 may employ a non-3GPP radio technology to communicate with the WTRU 102c over the air interface 198. The N3IWF 199 may also be in communication with the core network 109.

The RAN 105 may include gNode-Bs 180a and 180b. It will be appreciated that the RAN 105 may include any number of gNode-Bs. The gNode-Bs 180a and 180b may each include one or more transceivers for communicating with the WTRUs 102a and 102b over the air interface 117. When integrated access and backhaul connection are used, the same air interface may be used between the WTRUs and gNode-Bs, which may be the core network 109 via one or multiple gNBs. The gNode-Bs 180a and 180b may implement MIMO, MU-MIMO, or digital beamforming technology. Thus, the gNode-B 180a, for example, may use multiple antennas to transmit wireless signals to, and receive wireless signals from, the WTRU 102a. It should be appreciated that the RAN 105 may employ of other types of base stations such as an eNode-B. It will also be appreciated the RAN 105 may employ more than one type of base station. For example, the RAN may employ eNode-Bs and gNode-Bs.

The N3IWF 199 may include a non-3GPP Access Point 180c. It will be appreciated that the N3IWF 199 may include any number of non-3GPP Access Points. The non-3GPP Access Point 180c may include one or more transceivers for communicating with the WTRUs 102c over the air interface 198. The non-3GPP Access Point 180c may use the 802.11 protocol to communicate with the WTRU 102c over the air interface 198.

Each of the gNode-Bs 180a and 180b may be associated with a particular cell (not shown) and may be configured to handle radio resource management decisions, handover decisions, scheduling of users in the uplink or downlink, and the like. As shown in FIG. 11D, the gNode-Bs 180a and 180b may communicate with one another over an Xn interface, for example.

The core network 109 shown in FIG. 11D may be a 5G core network (5GC). The core network 109 may offer numerous communication services to customers who are interconnected by the radio access network. The core network 109 comprises a number of entities that perform the functionality of the core network. As used herein, the term “core network entity” or “network function” refers to any entity that performs one or more functionalities of a core network. It is understood that such core network entities may be logical entities that are implemented in the form of computer-executable instructions (software) stored in a memory of, and executing on a processor of, an apparatus configured for wireless or network communications or a computer system, such as system 90 illustrated in FIG. 11G.

In the example of FIG. 11D, the 5G Core Network 109 may include an access and mobility management function (AMF) 172, a Session Management Function (SMF) 174, User Plane Functions (UPFs) 176a and 176b, a User Data Management Function (UDM) 197, an Authentication Server Function (AUSF) 190, a Network Exposure Function (NEF) 196, a Policy Control Function (PCF) 184, a Non-3GPP Interworking Function (N3IWF) 199, a User Data Repository (UDR) 178. While each of the foregoing elements are depicted as part of the 5G core network 109, it will be appreciated that any one of these elements may be owned or operated by an entity other than the core network operator. It will also be appreciated that a 5G core network may not consist of all of these elements, may consist of additional elements, and may consist of multiple instances of each of these elements. FIG. 11D shows that network functions directly connect with one another, however, it should be appreciated that they may communicate via routing agents such as a diameter routing agent or message buses.

In the example of FIG. 11D, connectivity between network functions is achieved via a set of interfaces, or reference points. It will be appreciated that network functions could be modeled, described, or implemented as a set of services that are invoked, or called, by other network functions or services. Invocation of a Network Function service may be achieved via a direct connection between network functions, an exchange of messaging on a message bus, calling a software function, etc.

The AMF 172 may be connected to the RAN 105 via an N2 interface and may serve as a control node. For example, the AMF 172 may be responsible for registration management, connection management, reachability management, access authentication, access authorization. The AMF may be responsible forwarding user plane tunnel configuration information to the RAN 105 via the N2 interface. The AMF 172 may receive the user plane tunnel configuration information from the SMF via an N11 interface. The AMF 172 may generally route and forward NAS packets to/from the WTRUs 102a, 102b, and 102c via an N1 interface. The N1 interface is not shown in FIG. 11D.

The SMF 174 may be connected to the AMF 172 via an N11 interface. Similarly, the SMF may be connected to the PCF 184 via an N7 interface, and to the UPFs 176a and 176b via an N4 interface. The SMF 174 may serve as a control node. For example, the SMF 174 may be responsible for Session Management, IP address allocation for the WTRUs 102a, 102b, and 102c, management and configuration of traffic steering rules in the UPF 176a and UPF 176b, and generation of downlink data notifications to the AMF 172.

The UPF 176a and UPF 176b may provide the WTRUs 102a, 102b, and 102c with access to a Packet Data Network (PDN), such as the Internet 110, to facilitate communications between the WTRUs 102a, 102b, and 102c and other devices. The UPF 176a and UPF 176b may also provide the WTRUs 102a, 102b, and 102c with access to other types of packet data networks. For example, Other Networks 112 may be Ethernet Networks or any type of network that exchanges packets of data. The UPF 176a and UPF 176b may receive traffic steering rules from the SMF 174 via the N4 interface. The UPF 176a and UPF 176b may provide access to a packet data network by connecting a packet data network with an N6 interface or by connecting to each other and to other UPFs via an N9 interface. In addition to providing access to packet data networks, the UPF 176 may be responsible packet routing and forwarding, policy rule enforcement, quality of service handling for user plane traffic, downlink packet buffering.

The AMF 172 may also be connected to the N3IWF 199, for example, via an N2 interface. The N3IWF facilitates a connection between the WTRU 102c and the 5G core network 170, for example, via radio interface technologies that are not defined by 3GPP. The AMF may interact with the N3IWF 199 in the same, or similar, manner that it interacts with the RAN 105.

The PCF 184 may be connected to the SMF 174 via an N7 interface, connected to the AMF 172 via an N15 interface, and to an Application Function (AF) 188 via an N5 interface. The N15 and N5 interfaces are not shown in FIG. 11D. The PCF 184 may provide policy rules to control plane nodes such as the AMF 172 and SMF 174, allowing the control plane nodes to enforce these rules. The PCF 184 may send policies to the AMF 172 for the WTRUs 102a, 102b, and 102c so that the AMF may deliver the policies to the WTRUs 102a, 102b, and 102c via an N1 interface. Policies may then be enforced, or applied, at the WTRUs 102a, 102b, and 102c.

The UDR 178 may act as a repository for authentication credentials and subscription information. The UDR may connect with network functions, so that network function can add to, read from, and modify the data that is in the repository. For example, the UDR 178 may connect with the PCF 184 via an N36 interface. Similarly, the UDR 178 may connect with the NEF 196 via an N37 interface, and the UDR 178 may connect with the UDM 197 via an N35 interface.

The UDM 197 may serve as an interface between the UDR 178 and other network functions. The UDM 197 may authorize network functions to access of the UDR 178. For example, the UDM 197 may connect with the AMF 172 via an N8 interface, the UDM 197 may connect with the SMF 174 via an N10 interface. Similarly, the UDM 197 may connect with the AUSF 190 via an N13 interface. The UDR 178 and UDM 197 may be tightly integrated.

The AUSF 190 performs authentication related operations and connect with the UDM 178 via an N13 interface and to the AMF 172 via an N12 interface.

The NEF 196 exposes capabilities and services in the 5G core network 109 to Application Functions (AF) 188. Exposure may occur on the N33 API interface. The NEF may connect with an AF 188 via an N33 interface and it may connect with other network functions in order to expose the capabilities and services of the 5G core network 109.

Application Functions 188 may interact with network functions in the 5G Core Network 109. Interaction between the Application Functions 188 and network functions may be via a direct interface or may occur via the NEF 196. The Application Functions 188 may be considered part of the 5G Core Network 109 or may be external to the 5G Core Network 109 and deployed by enterprises that have a business relationship with the mobile network operator.

Network Slicing is a mechanism that could be used by mobile network operators to support one or more ‘virtual’ core networks behind the operator's air interface. This involves ‘slicing’ the core network into one or more virtual networks to support different RANs or different service types running across a single RAN. Network slicing enables the operator to create networks customized to provide optimized solutions for different market scenarios which demands diverse requirements, e.g., in the areas of functionality, performance and isolation.

3GPP has designed the 5G core network to support Network Slicing. Network Slicing is a good tool that network operators can use to support the diverse set of 5G use cases (e.g., massive IoT, critical communications, V2X, and enhanced mobile broadband) which demand very diverse and sometimes extreme requirements. Without the use of network slicing techniques, it is likely that the network architecture would not be flexible and scalable enough to efficiently support a wider range of use cases need when each use case has its own specific set of performance, scalability, and availability requirements. Furthermore, introduction of new network services should be made more efficient.

Referring again to FIG. 11D, in a network slicing scenario, a WTRU 102a, 102b, or 102c may connect with an AMF 172, via an N1 interface. The AMF may be logically part of one or more slices. The AMF may coordinate the connection or communication of WTRU 102a, 102b, or 102c with one or more UPF 176a and 176b, SMF 174, and other network functions. Each of the UPFs 176a and 176b, SMF 174, and other network functions may be part of the same slice or different slices. When they are part of different slices, they may be isolated from each other in the sense that they may utilize different computing resources, security credentials, etc.

The core network 109 may facilitate communications with other networks. For example, the core network 109 may include, or may communicate with, an IP gateway, such as an IP Multimedia Subsystem (IMS) server, that serves as an interface between the 5G core network 109 and a PSTN 108. For example, the core network 109 may include, or communicate with a short message service (SMS) service center that facilities communication via the short message service. For example, the 5G core network 109 may facilitate the exchange of non-IP data packets between the WTRUs 102a, 102b, and 102c and servers or applications functions 188. In addition, the core network 170 may provide the WTRUs 102a, 102b, and 102c with access to the networks 112, which may include other wired or wireless networks that are owned or operated by other service providers.

The core network entities described herein and illustrated in FIG. 11A, FIG. 11C, FIG. 11D, or FIG. 11E are identified by the names given to those entities in certain existing 3GPP specifications, but it is understood that in the future those entities and functionalities may be identified by other names and certain entities or functions may be combined in future specifications published by 3GPP, including future 3GPP NR specifications. Thus, the particular network entities and functionalities described and illustrated in FIG. 11A, FIG. 111B, FIG. 11C, FIG. 11D, or FIG. 11E are provided by way of example only, and it is understood that the subject matter disclosed and claimed herein may be embodied or implemented in any similar communication system, whether presently defined or defined in the future.

FIG. 11E illustrates an example communications system 111 in which the systems, methods, apparatuses that implement enablement of CAPIF API invocation by UE applications, described herein, may be used. Communications system 111 may include Wireless Transmit/Receive Units (WTRUs) A, B, C, D, E, F, a base station gNB 121, a V2X server 124, and Road Side Units (RSUs) 123a and 123b. In practice, the concepts presented herein may be applied to any number of WTRUs, base station gNBs, V2X networks, or other network elements. One or several or all WTRUs A, B, C, D, E, and F may be out of range of the access network coverage 131. WTRUs A, B, and C form a V2X group, among which WTRU A is the group lead and WTRUs B and C are group members.

WTRUs A, B, C, D, E, and F may communicate with each other over a Uu interface 129 via the gNB 121 if they are within the access network coverage 131. In the example of FIG. 11E, WTRUs B and F are shown within access network coverage 131. WTRUs A, B, C, D, E, and F may communicate with each other directly via a Sidelink interface (e.g., PC5 or NR PC5) such as interface 125a, 125b, or 128, whether they are under the access network coverage 131 or out of the access network coverage 131. For instance, in the example of FIG. 11E, WRTU D, which is outside of the access network coverage 131, communicates with WTRU F, which is inside the coverage 131.

WTRUs A, B, C, D, E, and F may communicate with RSU 123a or 123b via a Vehicle-to-Network (V2N) 133 or Sidelink interface 125b. WTRUs A, B, C, D, E, and F may communicate to a V2X Server 124 via a Vehicle-to-Infrastructure (V2I) interface 127. WTRUs A, B, C, D, E, and F may communicate to another UE via a Vehicle-to-Person (V2P) interface 128.

FIG. 11F is a block diagram of an example apparatus or device WTRU 102 that may be configured for wireless communications and operations in accordance with the systems, methods, and apparatuses that implement enablement of CAPIF API invocation by UE applications, described herein, such as a WTRU 102 of FIG. 11A, FIG. 11B, FIG. 11C, FIG. 11D, or FIG. 11E, or FIG. 4-FIG. 10. As shown in FIG. 11F, the example WTRU 102 may include a processor 78, a transceiver 120, a transmit/receive element 122, a speaker/microphone 74, a keypad 126, a display/touchpad/indicators 77, non-removable memory 130, removable memory 132, a power source 134, a global positioning system (GPS) chipset 136, and other peripherals 138. It will be appreciated that the WTRU 102 may include any sub-combination of the foregoing elements. Also, the base stations 114a and 114b, or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, a next generation node-B (gNode-B), and proxy nodes, among others, may include some or all of the elements depicted in FIG. 11F and may be an exemplary implementation that performs the disclosed systems and methods for enablement of CAPIF API invocation by UE applications described herein.

The processor 78 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 78 may perform signal coding, data processing, power control, input/output processing, or any other functionality that enables the WTRU 102 to operate in a wireless environment. The processor 78 may be coupled to the transceiver 120, which may be coupled to the transmit/receive element 122. While FIG. 11F depicts the processor 78 and the transceiver 120 as separate components, it will be appreciated that the processor 78 and the transceiver 120 may be integrated together in an electronic package or chip.

The transmit/receive element 122 of a UE may be configured to transmit signals to, or receive signals from, a base station (e.g., the base station 114a of FIG. 11A) over the air interface 115/116/117 or another UE over the air interface 115d/116d/117d. For example, the transmit/receive element 122 may be an antenna configured to transmit or receive RF signals. The transmit/receive element 122 may be an emitter/detector configured to transmit or receive IR, UV, Radar, LIDAR, or visible light signals, for example. The transmit/receive element 122 may be configured to transmit and receive both RF and light signals. It will be appreciated that the transmit/receive element 122 may be configured to transmit or receive any combination of wireless or wired signals.

In addition, although the transmit/receive element 122 is depicted in FIG. 11F as a single element, the WTRU 102 may include any number of transmit/receive elements 122. More specifically, the WTRU 102 may employ MIMO technology. Thus, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, for example NR and IEEE 802.11 or NR and E-UTRA, or to communicate with the same RAT via multiple beams to different RRHs, TRPs, RSUs, or nodes.

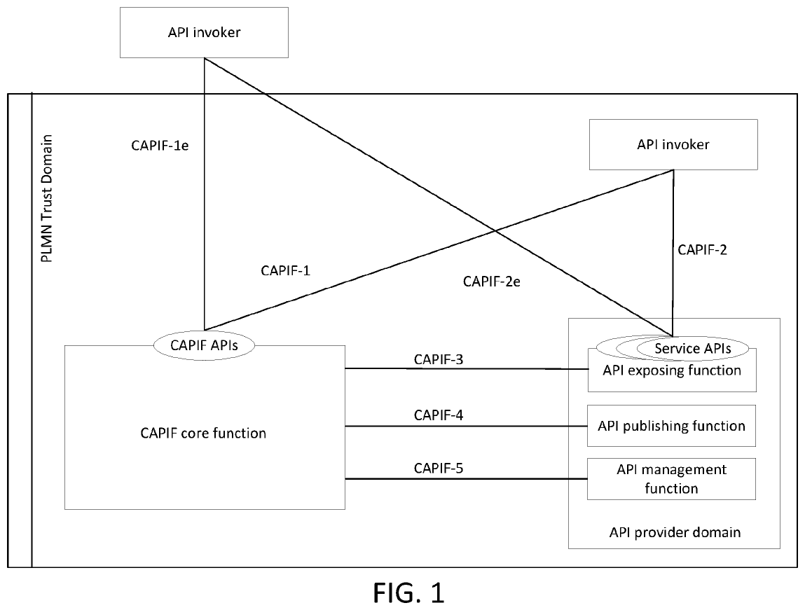

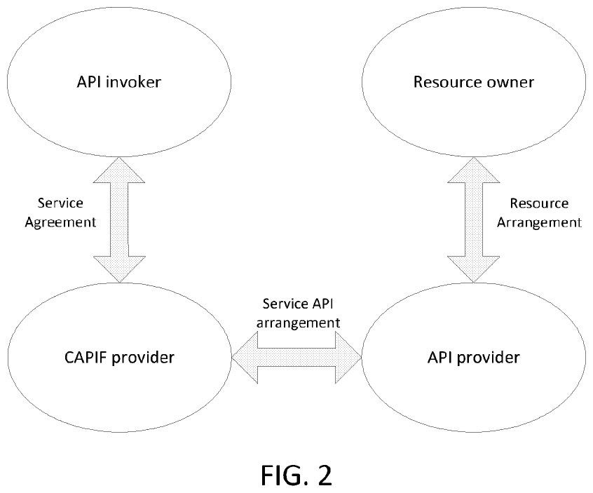

The processor 78 of the WTRU 102 may be coupled to, and may receive user input data from, the speaker/microphone 74, the keypad 126, or the display/touchpad/indicators 77 (e.g., a liquid crystal display (LCD) display unit or organic light-emitting diode (OLED) display unit. The processor 78 may also output user data to the speaker/microphone 74, the keypad 126, or the display/touchpad/indicators 77. In addition, the processor 78 may access information from, and store data in, any type of suitable memory, such as the non-removable memory 130 or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. The processor 78 may access information from, and store data in, memory that is not physically located on the WTRU 102, such as on a server that is hosted in the cloud or in an edge computing platform or in a home computer (not shown). The processor 78 may be configured to control lighting patterns, images, or colors on the display or indicators 77 in response to whether the setup of enablement of CAPIF API invocation by UE applications and associated components. The control lighting patterns, images, or colors on the display or indicators 77 may be reflective of the status of any of the method flows or components in the FIG.'s illustrated or discussed herein (e.g., FIG. 1-FIG. 10, etc.). Disclosed herein are messages and procedures of enablement of CAPIF API invocation by UE applications. The messages and procedures may be extended to provide interface/API for users to request resources via an input source (e.g., speaker/microphone 74, keypad 126, or display/touchpad/indicators 77) and request, configure, or query enablement of CAPIF API invocation by UE applications related information, among other things that may be displayed on display 77.

The processor 78 may receive power from the power source 134 and may be configured to distribute or control the power to the other components in the WTRU 102. The power source 134 may be any suitable device for powering the WTRU 102. For example, the power source 134 may include one or more dry cell batteries, solar cells, fuel cells, and the like.

The processor 78 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) or determine its location based on the timing of the signals being received from two or more nearby base stations. It will be appreciated that the WTRU 102 may acquire location information by way of any suitable location-determination method.

The processor 78 may further be coupled to other peripherals 138, which may include one or more software or hardware modules that provide additional features, functionality, or wired or wireless connectivity. For example, the peripherals 138 may include various sensors such as an accelerometer, biometrics (e.g., finger print) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The WTRU 102 may be included in other apparatuses or devices, such as a sensor, consumer electronics, a wearable device such as a smart watch or smart clothing, a medical or eHealth device, a robot, industrial equipment, a drone, a vehicle such as a car, truck, train, or an airplane. The WTRU 102 may connect with other components, modules, or systems of such apparatuses or devices via one or more interconnect interfaces, such as an interconnect interface that may comprise one of the peripherals 138.

FIG. 11G is a block diagram of an exemplary computing system 90 in which one or more apparatuses of the communications networks illustrated in FIG. 11A, FIG. 11C, FIG. 11D and FIG. 11E as well as enablement of CAPIF API invocation by UE applications, such as the systems and methods illustrated in FIG. 1 through FIG. 10 described and claimed herein may be embodied, such as certain nodes or functional entities in the RAN 103/104/105, Core Network 106/107/109, PSTN 108, Internet 110, Other Networks 112, or Network Services 113. Computing system 90 may comprise a computer or server and may be controlled primarily by computer readable instructions, which may be in the form of software, wherever, or by whatever means such software is stored or accessed. Such computer readable instructions may be executed within a processor 91, to cause computing system 90 to do work. The processor 91 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 91 may perform signal coding, data processing, power control, input/output processing, or any other functionality that enables the computing system 90 to operate in a communications network. Coprocessor 81 is an optional processor, distinct from main processor 91, that may perform additional functions or assist processor 91. Processor 91 or coprocessor 81 may receive, generate, and process data related to the methods and apparatuses disclosed herein for enablement of CAPIF API invocation by UE applications.

In operation, processor 91 fetches, decodes, and executes instructions, and transfers information to and from other resources via the computing system's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally include stored data that cannot easily be modified. Data stored in RAM 82 may be read or changed by processor 91 or other hardware devices. Access to RAM 82 or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 90 may include peripherals controller 83 responsible for communicating instructions from processor 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. The visual output may be provided in the form of a graphical user interface (GUI). Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may include communication circuitry, such as for example a wireless or wired network adapter 97, that may be used to connect computing system 90 to an external communications network or devices, such as the RAN 103/104/105, Core Network 106/107/109, PSTN 108, Internet 110, WTRUs 102, or Other Networks 112 of FIG. 11A, FIG. 111B, FIG. 11C, FIG. 11D, or FIG. 11E, to enable the computing system 90 to communicate with other nodes or functional entities of those networks. The communication circuitry, alone or in combination with the processor 91, may be used to perform the transmitting and receiving steps of certain apparatuses, nodes, or functional entities described herein.

It is understood that any or all of the apparatuses, systems, methods and processes described herein may be embodied in the form of computer executable instructions (e.g., program code) stored on a computer-readable storage medium which instructions, when executed by a processor, such as processors 78 or 91, cause the processor to perform or implement the systems, methods and processes described herein. Specifically, any of the steps, operations, or functions described herein may be implemented in the form of such computer executable instructions, executing on the processor of an apparatus or computing system configured for wireless or wired network communications. Computer readable storage media includes volatile and nonvolatile, removable and non-removable media implemented in any non-transitory (e.g., tangible or physical) method or technology for storage of information, but such computer readable storage media do not include signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other tangible or physical medium which may be used to store the desired information and which may be accessed by a computing system.

In describing preferred methods, systems, or apparatuses of the subject matter of the present disclosure—enablement of CAPIF API invocation by UE applications—as illustrated in the Figures, specific terminology is employed for the sake of clarity. The claimed subject matter, however, is not intended to be limited to the specific terminology so selected.

The various techniques described herein may be implemented in connection with hardware, firmware, software or, where appropriate, combinations thereof. Such hardware, firmware, and software may reside in apparatuses located at various nodes of a communication network. The apparatuses may operate singly or in combination with each other to effectuate the methods described herein. As used herein, the terms “apparatus,” “network apparatus,” “node,” “device,” “network node,” or the like may be used interchangeably. In addition, the use of the word “or” is generally used inclusively unless otherwise provided herein.

This written description uses examples for the disclosed subject matter, including the best mode, and also to enable any person skilled in the art to practice the disclosed subject matter, including making and using any devices or systems and performing any incorporated methods. The disclosed subject matter may include other examples that occur to those skilled in the art (e.g., skipping steps, combining steps, or adding steps between exemplary methods disclosed herein).

Methods, systems, and apparatuses, among other things, as described herein may provide for capabilities of user equipment which may be part of an application programming interface (API) exposure system or deployment. In an example, a method for UE onboarding with CCF via AF. The method may proceed as follows: receive a request from an application hosted on the UE, where the request comprises one or more descriptions of requested APIs; determine, based on a received request, a first network entity managing the requested APIs (CCF) and a second network entity exposing the requested APIs (AEF); determine to forward the onboarding request to the first network entity in order to enable the UE application access to the requested APIs; and send a response to the UE application. The response may include 1) result of the onboarding request, 2) information identifying the second network entity exposing the requested APIs, or 3) information enabling the UE application to invoke the requested APIs. The first network entity may be the same as the second network entity. The request may be an onboarding request. The request may include one or more of the following: an invocation if a requested API, owner information for obtaining API invocation consent. The request may include information identifying a resource owner that provides verification and validation of owner consent required for an invocation of the requested API by the UE application. The response may include information enabling the AF to invoke the requested APIs on behalf of the UE application. The first network application function (AF) may determine the first network entity (CCF) or the second network entity (AEF) based on UE location. The first network application function (AF) may later monitor UE location, determine a more suitable third network entity more suitable to expose the requested APIs (AEF) at a new location; and may provide the UE application with the updated information. Suitable may include an entity that is associated with that location and may serve that location (new), rather than the current UE location. All combinations in this paragraph (including the removal or addition of steps) are contemplated in a manner that is consistent with the other portions of the detailed description.

In another example, there may be a method for resource owner registration. The method may proceed as follows: determining, based on pre-provisioned information or a message from the UE, that a first UE hosted application provides owner consent for accessing a first API related to the UE or the UE application; and determining to register the ULE application as a resource owner with a first network entity in the 5G Core Network or interacting with the 5G Core Network, such that invocation of the first API related to the UE or the UE application results in the UE hosted application being triggered to provide owner consent if triggering corresponding core network API(s) related to the UE or the UE application may be desired. The first API related to the UE or the UE application is the core network API. The message from the UE may include one or more of the following: one or more identifiers of the owner, one or more application identifiers, one or more identifiers for APIs requiring consent, one or more consent triggering allowed conditions, or one or more contact addresses for targeting owner consent requests. All combinations in this paragraph (including the removal or addition of steps) are contemplated in a manner that is consistent with the other portions of the detailed description.

Methods, systems, and apparatuses, among other things, as described herein may provide for a first network application function (AF) providing 5G system management functionality to applications hosted on UEs; determining, based on pre-provisioned information or a message from the UE, that a first UE hosted application provides owner consent for accessing a first API related to the UE or the UE application; and determining to register the UE application as a resource owner with a first network entity in the 5G Core Network or interacting with the 5G Core Network, such that invocation of the first API related to the UE or the UE application results in the UE hosted application being triggered to provide owner consent if triggering corresponding Core Network API(s) related to the UE or the UE application is required. The first API related to the UE or the UE application may be the Core Network API. The message from the ULE may include one or more of the following: one or more identifiers of the owner, one or more application identifiers, one or more identifiers for APIs requiring consent, one or more consent triggering allowed conditions, or one or more contact addresses for targeting owner consent requests. All combinations in this paragraph (including the removal or addition of steps) are contemplated in a manner that is consistent with the other portions of the detailed description

Methods, systems, and apparatuses, among other things, as described herein may provide for a first network application function (AF) providing 5G system management functionality to applications hosted on UEs, to receive a request from an application hosted on the UE, where the request comprises one or more descriptions of requested APIs, determine, based on the received request, a first network entity managing the requested APIs (CCF) and a second network entity exposing the requested APIs (AEF); determine to forward (e.g., send) the onboarding request to the first network entity in order to enable the UE application access to the requested APIs; and send a response to the UE application that may include: result of the onboarding request, information identifying the second network entity exposing the requested APIs, and information enabling the UE application to invoke the requested APIs. The first network entity may be the same as the second network entity. The request may be an onboarding request. The request may include one or more of the following: an invocation if a requested API or owner information for obtaining API invocation consent. The request may include information identifying a resource owner that provides verification and validation of owner consent required for an invocation of the requested API by the UE application. The response also includes information enabling the AF to invoke (e.g., access) the requested APIs on behalf of the UE application. The first network application function (AF) may determine the first network entity (CCF) or the second network entity (AEF) based on UE location. The first network application function (AF) may later monitor UE location, may determine a more suitable a third network entity more suitable to expose the requested APIs (AEF) at a new location; and may provide the UE application with the updated information. All combinations in this paragraph (including the removal or addition of steps) are contemplated in a manner that is consistent with the other portions of the detailed description.

Methods, systems, and apparatuses may provide for a network application function (AF) providing 5G system (5GS) management functionality to applications hosted on one or more user equipments (UEs). Methods, systems, and apparatuses, among other things, as described herein may provide for receiving a request with information associated with a user equipment (UE), the information associated with the UE comprises: an identifier that indicates that a first application is hosted on the UE (e.g., UE hosted application); determining, based on pre-provisioned information or the received message from the UE, that the first UE hosted application hosted provides owner consent for accessing a protected resource when invoking a first application programming interface (API); determining to register the first UE hosted application as a protected resource owner with a second network application function in the 5G system, such that invocation of the first API results in the first UE hosted application being triggered to provide owner consent. The first API may be the one that gets invoked and results in trying to access the protected resource. Methods, systems, and apparatuses, among other things, as described herein may further provide for sending a request response, the request response comprises an indication whether the UE hosted application is registered as a protected resource owner. All combinations in this paragraph and the previous paragraphs (including the removal or addition of steps) are contemplated in a manner that is consistent with the other portions of the detailed description.

Methods, systems, and apparatuses, among other things, as described herein may provide for receiving information associated with a user equipment (UE), the information associated with the UE comprises an indication of an invocation of the first API that corresponds to one or more network APIs; determining, based on the information associated with the UE, there is an indication of owner consent for accessing a first application programming interface (API) related to the UE or a UE application; registering the UE application as a resource owner with a first network entity in a network; receiving an indication of an invocation of the first API that corresponds to one or more network APIs; and based on the indication of the invocation of the first API and the indication of the owner consent, sending a notification associated with the first API. Methods, systems, and apparatuses, among other things, as described herein may provide for monitoring location of the UE; based on the location, determining a third network entity to expose the requested APIs at a second location; and sending updated information associated with the requested APIs to the application hosted on the one or more UEs, wherein the updated information comprises information associated with the third network entity. All combinations in this paragraph and the previous paragraphs (including the removal or addition of steps) are contemplated in a manner that is consistent with the other portions of the detailed description.

Methods, systems, and apparatuses, among other things, as described herein may provide for receiving a request from an application hosted on the one or more UEs, wherein the request comprises one or more descriptions of application programming interfaces (APIs); determining, based on the request, a first network entity and a second network entity, wherein the first network entity manages the described APIs, wherein the second network entity exposes the described APIs; determining to send an onboarding request to the first network entity in order to enable the application hosted on the one or more UEs access to the described APIs; and sending a response to the application hosted on the one or more UEs. Methods, systems, and apparatuses, among other things, as described herein may provide for sending a response to the application hosted on the one or more UEs comprises: result of the onboarding request, information identifying the second network entity exposing the requested APIs, and information enabling the application hosted on the one or more UEs to access the requested APIs. All combinations in this paragraph and the previous paragraphs (including the removal or addition of steps) are contemplated in a manner that is consistent with the other portions of the detailed description.

1. A method for an application function (AF) of a network, the AF providing 5G system management functionality to applications hosted on a user equipment (UE), the method comprising:
receiving a request from an application hosted on the UE, wherein the request comprises one or more descriptions of application programming interfaces (APIs);
determining, based on the request and pre-provisioned information, a first network entity and a second network entity a set of onboarding conditions, wherein the first network entity manages authorization of a UE as an API invoker, wherein the second network entity exposes the APIs;
determining to send an onboarding request comprising the set of onboarding conditions to the first network entity in order to enable the application hosted on the UE access to the APIs; and
sending a response to the application hosted on the LE comprises:
result of the onboarding request;
information identifying the second network entity exposing the APIs; and
information enabling the application hosted on the LE to access the APIs.

2. The method of claim 1, wherein the first network entity is a common API framework core function (CCF).

3. The method of claim 1, wherein the second network entity is an API exposure function (AEF).

4. The method of claim 1, wherein the first network entity and the second network entity are the same.

5. The method of claim 1, wherein the AF is a common API framework function.

6. (canceled)

7. The method of claim 1, wherein the request comprises: an invocation of a described API and information for obtaining API invocation consent.

8. The method of claim 7, wherein the information for obtaining API invocation consent comprises:
information identifying a resource owner.

9. The method of claim 1, wherein the response comprises information enabling the AF to invoke the APIs on behalf of the UE hosted application.

10. The method of claim 1, further comprising determining the first network entity or the second network entity based on a location of the UE.

11. The method of claim 1, further comprising:
monitoring location of the UE;
based on the location, determining a third network entity to expose the APIs at a second location; and
sending updated information associated with the APIs to the UE hosted application, wherein the updated information comprises information associated with the third network entity.

12. A method for an application function (AF) providing 5G system management functionality to applications hosted on a user equipment (UE), the method comprising:
receiving a request with information associated with the UE, the information associated with the UE comprises an identifier that indicates a UE hosted application;
determining, based on pre-provisioned information and the request, that the UE hosted application provides owner consent for accessing a protected resource when an application programming interface (API) is invoked;
determining to register the UE hosted application with a second network application function in a 5G system, such that invocation of the API results in the UE hosted application being triggered to provide owner consent; and
sending a request response, the request response comprises an indication whether the UE hosted application is registered with the second network application function.

13. The method of claim 12, wherein the information associated with the UE comprises one or more identifiers of applications hosted on the UE.

14. The method of claim 12, wherein the second network application function uses information in a message of the UE hosted application client and pre-provisioned information about the API requiring owner consent to determine a protected resource owner.

15. The method of claim 14, wherein the information used to determine the protected resource owner comprises one or more consent triggering allowed conditions.

16. The method of claim 14, wherein the information used to determine the protected resource owner comprises one or more contact addresses for targeting owner consent requests.

17. An apparatus comprising:
a processor; and
a memory coupled with the processor, the memory storing executable instructions that when executed by the processor cause the processor to effectuate operations to:
receiving a request from an application hosted on a user equipment (UE), wherein the request comprises one or more descriptions of application programming interfaces (APIs);
determining, based on the request and pre-provisioned information, a first network entity and a second network entity a set of onboarding conditions, wherein the first network entity manages authorization of a UE as an API invoker, wherein the second network entity exposes the APIs;
determining to send an onboarding request comprising the set of onboarding conditions to the first network entity in order to enable the application hosted on the UE access to the APIs; and
sending a response to the application hosted on the UE comprises:
result of the onboarding request;
information identifying the second network entity exposing the APIs; and
information enabling the application hosted on the UE to access the APIs.

18. The apparatus of claim 17, wherein the first network entity is a common API framework core function (CCF).

19. The apparatus of claim 17, wherein the second network entity is an API exposure function (AEF).

20. (canceled)

21. The apparatus of claim 17, wherein the first network entity and the second network entity are the same.

22. The method of claim 12, wherein the pre-provisioned information comprises one or more identifiers for APIs requiring owner consent for accessing protected resources.
